(19) United States
(12) Patent Application Publication
(10) Pub. No.: US 2012/0278200 A1
(43) Pub. Date: Nov. 1, 2012

(54) Value Banking System And Technique Utilizing Complementary Value Currency

(76) Inventors: Bart P.E. van Coppenolle, Leuven (BE); Philip W.J. Vandormael, Leuven (BE)

(21) Appl. No.: 13/525,942

(22) Filed: Jun. 18, 2012

Related U.S. Application Data
(63) Continuation-in-part of application No. 13/278,789, filed on Oct. 21, 2011.
Application No. 13/278,789 is a continuation-in-part of application No. PCT/EP11/68485, filed on Oct. 21, 2010.
(60) Provisional application No. 61/497,752, filed on Jun. 16, 2011.
(60) Provisional application No. 61/510,803, filed on Jul. 22, 2011.
(60) Provisional application No. 61/536,857, filed on Sep. 20, 2011.
(60) Provisional application No. 61/563,982, filed on Nov. 28, 2011.
(60) Provisional application No. 61/646,409, filed on May 14, 2012.
(60) Provisional application No. 61/405,460, filed on Oct. 21, 2010.
(60) Provisional application No. 61/540,812, filed on Sep. 29, 2011.
(60) Provisional application No. 61/540,259, filed on Sep. 28, 2011.
(60) Provisional application No. 61/540,259, filed on Sep. 28, 2011.
(60) Provisional application No. 61/479,648, filed on Apr. 27, 2011.
(60) Provisional application No. 61/412,206, filed on Nov. 10, 2010.
(60) Provisional application No. 61/405,466, filed on Oct. 21, 2010.

(51) Int. Cl. G06Q 40/00; G06Q 30/00

(52) U.S. Cl. 705/26.35; 705/35; 705/36 R

(57) ABSTRACT

A new physical currency and any electronic token thereof is exchangeable for tangible goods or intangible services and has a value that is stabilized by an underlying stock portfolio or other asset having intrinsic value, the short term market value of which is arbitrated directly or indirectly by a central value bank.

### CROSS-REFERENCE TO RELATED APPLICATIONS

This application claims priority to the following co-pending U.S. Patent Applications, the subject matters of which are incorporated herein by this reference for all purposes, including the following:

U.S. Provisional Patent Application Ser. No. 61/497,752, filed on Jun. 16, 2011, entitled METHOD AND SYSTEM FOR COLLABORATIVE FREE MARKET BANKING AS AN ALTERNATIVE TO FRACTIONAL-RESERVE BANKING SYSTEMS, attorney docket number 44785.00100 PROV;

U.S. Provisional Patent Application Ser. No. 611510,803, filed on Jul. 22, 2011, entitled METHOD AND SYSTEM FOR COLLABORATIVE FULL RESERVE BANKING BACKED BY PUBLICLY TRADED VALUE STOCK BASED ON NEUROPSYCHOLOGICAL INSIGHTS, attorney docket number 44785.00100 PROV 2;

U.S. Provisional Patent Application Ser. No. 61/536,857, filed on Sep. 20, 2011, entitled METHOD AND SYSTEM FOR COLLABORATIVE FREE FULL-RESERVE BANKING AS AN ALTERNATIVE TO FRACTIONAL-RESERVE BANKING SYSTEMS, attorney docket number 44785.00100 PROV 3;

U.S. Provisional Patent Application Ser. No. 61/563,982, filed on Nov. 28, 2011, entitled METHOD AND SYSTEM FOR COLLABORATIVE FREE FULL-RESERVE BANKING AS AN ALTERNATIVE TO FRACTIONAL-RESERVE BANKING SYSTEMS, attorney docket number 44785.00100 PROV 5;

U.S. Provisional Patent Application Ser. No. 61/646,409, filed on May 14, 2012, entitled METHOD FOR PROTECTING AGAINST FINANCIAL CRISES THROUGH A COMPLEMENTARY VALUE CURRENCY AND A VALUE BANKING SYSTEM, attorney docket number 44785.00100 PROV 9;

U.S. patent application Ser. No. 13/278,789, filed on Oct. 21, 2011, entitled METHOD AND APPARATUS FOR NEUROPSYCHOLOGICAL MODELING OF HUMAN EXPERIENCE AND PURCHASING BEHAVIOR, attorney docket number 44785.00101; and

International Patent Application Serial No. PCT/EP11/68485, filed on October 21, 2011, entitled METHOD AND APPARATUS FOR NEUROPSYCHOLOGICAL MODELING OF HUMAN EXPERIENCE AND BEHAVIOR, attorney docket number 44785-101 PCT.

### BACKGROUND OF THE INVENTION

1. Field of the Invention

The disclosure relates to banking systems, and, more specifically, to a free-market banking system and a currency for exchanging goods and services in which the value of money is directly tied to underlying assets.

2. Evolutionary Neuropsychology and Economics

Objective economic knowledge or economic science can grow when Human Action or the human Free Will can further be reduced in Objects.

New insights in Human Action can be induced from studying human history. The history of mankind can be brought into the consciousness, by studying Cultural history through texts and religious symbols.

Reducing the Free Will requires a more Objective knowledge of the human psyche. Psychology can contribute new insights to Economics, as long as it is capable of growing Objective knowledge of the psyche. Psychology reduces the human psyche into Objects, but has been hampered in its scientific success by the lack of direct Objective measurements, because the psyche was only measurable through the answers or behavior of the Subject itself, the psyche, interpreted gain by a Subject or psyche. The yet un-reducible, remaining Subject of psychology is still the Free Will and eventually Economics has been left again with this irreducible Subject, the Free Will being anyhow the axiom behind the study of Free Human Action, called Economics.

Direct measurements of the brain have become possible over the last decades, growing new Objective knowledge of the psyche, through the study of the brain. It is the aim of neuropsychology to further reduce the psyche, some even claim to the point where the Free Will is reduced to no thing, nothing.

The growth of Objective knowledge about the brain and its psyche enables revisiting the science of economics inducing new insight and formulate new Objective conjectures. Based on this evolving Science, new technology is developed in this disclosure.

This disclosure describes an economic invention based on new economic insights, enabled by neuropsychology and the light neuropsychology sheds on Cultural history. To describe the new insights laying at the basis of the new technology and invention, it is necessary to dig into the evolution of the psyche embedded in the brain, during the last 550 million years and into the Cultural evolution of the psyche outside the brain, during the last 200 thousand years, and specifically the last 5 thousand years, when the Left Brain Consciousness gained dominance.

Bilaterally Symmetric Objects Project a Bivalent Subjective World

An animal is an animated being: a being with a psyche. Anima is the Latin translation for the Ancient Greek psyche.

Early animals evolved axisymmetry, a rotational symmetry around one axis of movement or Action. An axisymmetric animal Objected against a change in the environment, such as a change in temperature by moving along the axis of its symmetry, as e.g. a jellyfish does.

Animals have since at least 550 million years evolved bilateral symmetry. A bilateral body enabled a more dynamically movement through fluids, such as water. A bilateral animal can not only Object to change in the environment, away from the threat. A bilateral animal can also create change by choosing its own desired direction of movement, independently from the change of the external environment. A bilateral animal can not only Object, but also Subject to change or be the Subject creates change or acts. The psyche of bilateral symmetrical animals could evolve in two dimensions.

The bilateral brain was perfectly suited to support the evolution of this bivalent psyche. The bilateral brain evolved bivalent Subject and Object representations of phenomena dealing with bivalent Emotions such as Fear and Desire. The bilateral symmetric brain with its bivalent psyche became evolutionary very successful. And that shouldn't surprise.

The two Darwinian criteria for evolutionary success are: 1) natural selection and 2) sexual selection. It is therefore not surprisingly to notice that, given the bilateral shape, the psyche evolved successfully, when using its bilateral brain capability to match with its will both evolutionary criteria.

After all wouldn't any Subject be willing to be fitted for survival? In the same way that the own aleatory direction of movement can be assigned to the moving of an individual's Subject's will, wanting to move in that direction, also the successful evolution of our specie's Subject can be assigned to the successful spirit of mankind, also called the Holy Spirit or God.

The evolution of the animal psyche becomes very successful in the Homo sapiens with its key differentiating pre-frontal cortex, from where consciousness is bivalently directed.

But the success of the spirit did not start with consciousness as we know it now. The most primitive consciousness is being alive and that is reflected in the evolutionary most ancient part of the brain, the brain stem.

Motivation in the Brain Stem

Apart from being awake, or even just alive, the brain stem is involved with primitive motivation such as pain and reward. Reward is a form of immediate pleasure, resulting from Good behavior. The Subject who rewards is difficult to think Objectively, but Subjectively it is the same Subject that is actually successful.

Motivation is the Subjective spiritual force that causes movement, as suggested by the etymology of motivation. Motivation has evolved from the Latin word for moving ‘movere’, also found in the motor that moves or in Emotion. Motivation is the most primitive and immediate (without delay) Subjective cause of Human (and animal) Action. The real Objective mechanical cause of movement is not situated in the brain stem, but in the muscles, the information source however is the psyche. Motivation is an Objective part of the Subjective psyche and is incorporated in the brain stem. Activation can Objectively be measured through a brain scan.

Bivalent Emotion in the Limbic System

On top of the brain stem the next evolutionary most ancient development is the limbic system. It is the seat of Emotion, from where people (and animals) are spiritually moved, hence the etymology of the word Emotion. Emotion in the limbic system allows the psyche to feel, from within its incorporated brain, future pain and reward. Particularly a) the amygdalae and b) the nuclei accumbens and the putamen specialized respectively in a) negatively valenced emotion or Fear and b) positive valenced emotion or Desire.

Given the bilateral symmetry of the Objective physical brain, it is again not surprising to notice from empirical neuropsychological studies that Emotion is rather bivalent or two-dimensional, than bipolar or one-dimensional, contrary to what the words positive and negative suggest.

Neither is it surprising to notice that a lateralized preference exists in the limbic Right and Left Brain, where the Left and Right limbic Brain specialized in Fear and Desire, respectively.

Neocortical Projections, Dealing with Emotion

The evolutionary youngest part of the brain is the neocortex, the outer bark or cortex of the brain. It has evolved to represent phenomena, in order to be able to link limbic

Emotions with these representations and afterwards execute Action and actual movements. The human species uniquely differentiates from other species, through its most complex, furthest evolved neocortex, particularly the part behind the forehead, called the frontal cortex.

The Left neocortex, mainly connected with the Left limbic system and therefore evolutionary as most successful to deal with Fear or negative emotion by Objecting to Fear, while the Right neocortex successfully dealt with Desire or positive emotion, by Subjecting to it.

The most successful way to deal with Fear, in order to fit natural selection and avoid dead before procreation, is to Object to the changing phenomena that are emotionally linked with future pain. The mental projections formed under the direction of the Left pre frontal cortex are Objects. Objects allowed the Homo sapiens to project the world as reality, detecting real, objective risks and hedge these risks, by using technology, the name given to objective knowledge that actually works to reduce risks.

Since the most successful way to deal with Desire, in order to fit sexual selection and be chosen by a sexual mate to procreate, is to Subject to the change in phenomena that we are emotionally linking with future reward, the mental projections formed under the direction of the Right pre frontal cortex evolved into Subjects. Subjects allowed the Homo sapiens to project the spiritual world, Subjectively recognizing Good spirits, worth procreating with, recognizing Values in other Subjects. So, the brain of the Homo sapiens and its associated spirit became the human version of the peacock's tale, fitting the Darwinian sexual selection criterion and propelling the evolution of the brain and spirit.

The Objective Mechanism Behind the Subjective Psyche

Phenomena are not directly present in the human consciousness, but are pre-consciously registered by the senses and the backend of the cortex and only afterwards brought into the consciousness by the two pre-frontal cortices.

Consciousness emerges when neural circuits are repeatedly stimulated. The pre frontal cortex is particularly specialized in repeatedly stimulating other cortical regions, directing attention to representations and bringing them in the consciousness. Emotions draw the attention of the pre-frontal cortices to representations of phenomena.

When the raw data of the senses enter the brain, the thalamus projects them on the occipital, parietal and temporal lobes. The temporal lobes extract emotional valence, mainly Fear and sexual arousal by associating with the amygdalae. The orbitofrontal cortex is activated by this emotional arousal.

When the problem causing the Fear is known, the arousal level is again diminished by Objective, analytical thinking and subsequent Action, successfully solving the problem. This rational thinking occurs under direction of the Left pre-frontal cortex, using inhibiting acetylcholine feedforward, reducing the problematic phenomenon to its essential cortical representation and excitatory dopamine feedback, as the reward for correct problem detection and solution.

When the problem causing the Fear is unknown the arousal level is increased by divergent thinking, soliciting other cortical regions for potential solutions (ideas) by excitatory noradrenaline feedforward and thanking them or laying them off with inhibitory serotonin feedback. This intuitive thinking occurs under direction of the Right pre-frontal cortex. The mental projection created under direction of the Right pre-frontal cortex are ideas or Subjects. Indeed, it deals divergently not just with Fear, but also with sexual arousal, by projecting a transcendent Subject or psyche worth loving and procreating with.

Mirroring neurons typically mirror someone else's movement. When they mirror the movement of the face of the other, they also mirror the emotion associated with those facial expressions. When the intuitive divergent thinking of the Right Brain Consciousness, integrates not only other cortical regions, but also through faces and eyes the emotions of other people, empathy emerges, integrating the pathos of the other enters the own psyche and with it also representation. Finally the own consciousness gradually evolves towards a mirror of the Subjective psyche of the others in the community. That is how the spirit procreates, independently from the brain's DNA.

So it also happened that the divergent cortical projection under direction of the Right pre-frontal cortex, Right Brain projections of Desire, became Subject(s), the transcendental image of the spirit or the psyches of other community members with Good Values, worth procreating with.

The convergent cortical projection under direction of the left pre-frontal cortex, the Left Brain projections of Fear, became Objects. The Left pre-frontal cortex is directing linear language based consciousness and is one dimensional. The right pre-frontal cortex directs image, Subject or idea based consciousness and is two dimensional, the two dimensions of the eye as well as Emotional Valence.

Since the Left and Right pre frontal cortexes direct the whole cortex, also the contralateral part through the corpus callosum, the world as human beings experience, is fundamentally bivalent. All phenomena are both Subject and Object at the same time. Objects have evolutionary proven to work better to defend against unwanted phenomena, while Subjects are evolutionary more successful to want, to love, to bond or to procreate with.

The Objective world is real, the Subjective world is true. They're both mere mental projections. Subject projections allow the spirit of the specie to successfully evolve over generations becoming truly sustainable. Object projections make sure that Fears are dealt with Objectively. In order to make sure a technical solution solves a real problem or threat, it should be Objective. Only Objective solutions solve problems and hedge risks.

Desire for community is truly served by Subjective, empathic thinking, Fear for threats by Objective thinking. The deep chasm between the two human cortices, is an evolutionary indication not to confuse Desire with Objective thinking, such as in stimulating the economy, or Fear with Subjective thinking, such as in demonizing capitalists. Both are not successful. Since about 200 000 years the Homo sapiens has genetically evolved, only very little. However the spirit has continued evolution through artistic and religious symbols and Values, collectively shared in communities and bundled in Cults of local deities, as well as through linear language and technology, in human Culture.

The Free Human Action studied by Economics is therefore a result of 550 million years of evolving brain and 200 thousand years of Cultural evolution. Only the last 5000 years we call History, since written language only Culturally evolved so recently.

Gift Economy at the End of the Last Ice Age

After the end of the last ice age, about 12000 years ago, global warming initially resulted in improving agrarian conditions on earth. The abundance of naturally existing food for relatively small groups of people didn't necessitate real work or economic activity. This initial period of abundance still resonates in ancient Mesopotamian stories, such as the Garden of Eden. Scarcity did not yet exist, although it certainly had existed during most of the 190 000+ years of humanity, preceding this period. Sharing therefore was a very natural phenomenon, at that time. People lived in tribes, as extended families of genetically (and Culturally) connected groups of people.

The sacrifices they made for their gods (their fitness for survival) ritually exercised this sharing within their community. Also sharing between tribes was a common practice, from which today's—not only Japanese—habit to bring a gift when visiting another family or person still stems. People did not yet use money (although they might have used it in scarcer previous periods), neither needed to exchange goods in barter trade, given the available abundance. Therefore the economy consisted to a big extent of gift economy. The only returning favor was a graceful thank you, as resonates in the Italian, Japanese or Portuguese words ‘grazie’, ‘arigato’ and ‘obrigado’ for thank you or ‘I am obliged’ for a gratuity, free of charge or gratis. Graceful, grazie, gratuity and gratis still mark this intricate interconnection of meaning.

Tax was not a forced contribution of scarce resources to the leadership of a community, but the free sharing between community members and occasionally between communities, that were essentially tribes or families, not civilian communities in cities.

Contemporary problems such as overleveraged, failing governments, lack of economic growth and paralyzing government taxation did simply not exist in Eden's Paradise, when money did not exist and the only obligation in return for a free gift was a graceful thank you.

Agriculture and Barter Trade

When the human species became more successful and the number of people started to grow exponentially, abundance would have turned into scarcity, wouldn't mankind have invented agriculture, the Culture of sedimentary agrarian Activity.

Agriculture was no longer compatible with the gift economy. Agriculture requires work, (by the sweat of his brow Adam had to work to have food to eat, when thrown out of paradise). ‘Food was no longer for free’, is another economic relevant historical conclusion derived from this Mesopotamian story.

During abundance, gifts were given for free and people were gracefully thankful and would anyhow return the favor, sooner or later. With the threat of scarcity the Fear evolved that people would not return a favor. A good act performed for a lazy (or otherwise unsuccessful) community member may very well cause own food scarcity in the future, as still resonating in the modern fairytales of La Fontaine's The Ant and the Grasshopper.

Good acts became goods and reassured returning favors or obligations became exchanges of goods. The thankfulness expressed at the reception of a gift became the Value people attribute to a favor, good act or good performed for, or delivered to them.

Starting from free gifts as favors in abundance, Fear for scarcity and the obligation to return an equivalent (meaning having the same Value) favor Culturally evolved and with it exchange of (equivalent) goods, giving birth to a barter trade economy.

Rights, Contract, First Written Language and Money

Because goods were not always available at the moment people expressed their intention to trade, tokens were pressed in clay balls, as first contracts expressing the rights of parties to goods, in the future. When the exact agreement of Value between favor and returned favor was Feared to be Subjectively forgotten or misinterpreted by the other party, people could refer to the tokens in the clay balls as an Objective means to exclude any

Bivalence or non-consistency between the trading parties or Subjects. The tokens, safely stored in these clay balls formed the first agreement. When physical tokens were replaced by pictograms and simple numbers pressed into clay, the first written language evolved from commercial agreements.

Because goods were not always available at the moment of trading, some goods were selected to function as an intermediary storage of Value, to allow the trade to be executed, in the absence of at least one of the goods. Primitive Money was created when grain, salt or life stock were used to temporarily store Value.

When people saved part of their production, for future consumption or investment, the longer term Value storage capacity of Money evolved Culturally.

Kings, the Law and Cities

This Cultural evolution took about 5000 years of climate change, during which sea levels rose more than 100 meters—explaining another Mesopotamian story of Noah's Ark. At the end of this period fertile grounds started turning into desserts in the regions around Mesopotamia and the Egyptian Nile Delta.

The scarce resource—water—was monopolized by the most powerful men. They often used physical violence to dominate other people. The more than 5000 years old Narmer Palette is one of the oldest Ancient Egyptian writings. It is also one of the oldest known forms of political propaganda and depicts the ‘unification of Egypt’, in fact the ruler of Upper Egypt suppressing Lower Egypt, with its fertile grounds of the water filled Nile delta, by using physical violence. The Narmer Palette marks the intricate interplay between water scarcity, political power, violence, kings, writing and eventually the law applied in cities. In the Sumerian Mesopotamian cities kings and their laws became even more omnipotent, than in Egypt. As expressed in the most ancient Mesopotamian stories of all, Gilgamesh, powerful kings ruled but their empires were destroyed and their spirit was not successful. Gilgamesh is the archetypical Mesopotamian King who although he could kill the God's bull, eventually failed to obtain immortality. This is the Empire Fallacy, controlling Subjects does not bring success.

While agriculture and trade evolved Culturally to deal Objectively with the Fear for scarcity, caused by the Objective threat posed by the success of mankind, the social order of kings and their violently reinforced laws, evolved Culturally to deal Subjectively with the Fear for scarcity, caused by Objective reality, more specifically climate change. The Object of Fear was initially the real risk of scarcity, the hedge became production, trade, rights and agreements, or a free economy. Subsequently climate change became a new real threat; the solution that Culturally evolved was politics, named after the cities that Culturally evolved as an objective hedge against this climate change threat.

Political economy did not start 150 years ago, but rather 5150 years ago.

Ancient Greece

The story of the birth of democracy in Athens, 2500 years ago, exemplifies the deficiencies of modern political economy. The people of Greece understood that the physical violence of Tyrants, whether from abroad or at home, did not make them successful, fitted for survival as a Culture and people. They were successful in deferring the risk of foreign tyranny, defeating (one of) the first empires in human history, the Persian Empire.

However Perikles also invented modern politics, where power is not directly based on physical violence, but on the Desire of humans to belong to the group and the Fear to be expelled from the group, without necessarily excluding physical violence, from time to time, as e.g. shown from Plato's dead penalty. Perikles subsidized more than half of the Athenian economy, creating a loyal Cultural elite which the vast majority of Athenians craved to join and so securing his lifelong re-election, as a soft tyrant of Athena. The necessary funds to finance his deficit spending, he draw as a loan from the treasury of the Delian League, a league created to financially hedge the risk of new Persian invasions. There is some resemblance to European Union rescue funds or American quantitative easing.

The relation between tyrants and democracy, soft power and regular violence, Cultural elite and particracy, deficit spending and political economy and finally government loans and inflation all go back to ancient Greece, where not modern democracy but contemporary politics was invented.

Just as Ramses II of Egypt started the end of the Egyptian Culture when he subsidized its last Cultural eruption, causing inflation and decline, while creating an Empire, so did Perikles initiate the end of the Athenian culture when he created an Empire that was defeated by Sparta. The decadent political Culture was still powerful enough to murder Plato. And Aristotle could still inspire the Macedonian Alexander to continue the Imperial Fallacy. With Perikles' Empire, Athenian democracy did not evolve to include Free Human Action or free enterprise but failed in political economy.

Rome

With Caesar, also Rome fell to the Imperial Fallacy, abandoning its agriCultural and mercantile democratic republic to switch over to Caesar's Empire. Murdering Caesar was an unsuccessful attempt to stop the start of the Roman decadence. Just as Alexander had done, Julius Caesar was the first to show his own image on Money. Installing Fiat Money, the power of the Emperor defined the Value of Money, rather than the Value of the metal used, explaining why coins were continuously re-minted into new currency with the same face Value, but less metallic content, contributing to the financing of the emperors deficit, while causing inflation. Metallic Fiat Money had a nominal face Value and an Intrinsic Value, the Value of the metal it contained. The less metal the currency contained, the lower the Value of the currency became, creating Monetary Inflation.

By the end of the first Julio-Claudian dynasty, Nero was insanely popular (just as Perikles had been), inflation killed the once free Roman economy and Roman culture decayed.

Loaning Kings and Banking Goldsmiths

The Intrinsic Value of contemporary Fiat Money currencies is no longer determined by the Value of the metal the currency contains or represents, but by the Value of the assets the banks and central banks hold against the issued Money.

It all resulted from the infamous goldsmiths who invented fractional reserve paper money as a certificate claiming to be good for gold, while in fact it was a certificate mainly good for debt.

English merchants started storing their gold savings with goldsmiths, after King Charles I of England had confiscated private gold that was until then securely stored at the Royal Mint, as a forced loan to the king, in 1640. A political trick Perikles had already shown, with the Delian treasure, two millennia earlier. These goldsmiths started, for reasons of security and ease of transport, issuing paper notes representing gold. Subsequently they started loaning out these notes instead of gold, resulting in those notes no longer to be certificates good for gold only, but gradually mutating to certificates mainly good for debt. When people discovered that the notes were in fact issued against debt and not gold, they tried to secure their gold and the first bank run was a fact.

The solution to bank runs that was invented was fractional reserve banking. The central bank, being loosely under the control of the government, acted as a lender of last resort through its power to create unlimited amount of Money against assets such as government debt, among other assets without Intrinsic Value.

Today, when the Market Value of government debt or toxic real estate debt declines, the Intrinsic Value of contemporary Fiat Money, such as the US dollar or the Euro, declines, because the central bank issued the Money against these assets or holds these assets as collateral for debt it holds on its balance sheet.

Disadvantages of the Prior Art

The current art is characterized by political soft and hard power over Free Human Action, more specifically political power over Subjective Value expressed in Objective Money, as is the case with Fiat Money with Fractional Reserve.

The current art of Fiat Money combined with a Fractional Reserve Banking system has the disadvantages of creating Monetary Confusion (1). Monetary Confusion subsequently leads to economic cycles with bubbles or booms and crashes or recessions (2) that undermine Public Wealth (3) and often lead to war (4) and the decadence of human Culture (5). These are the five main disadvantages of the prior art.

Contemporary National Currencies

Most, but not all, contemporary currencies are national Fiat currencies. The Objective Nominal Value is enforced by Legal Tender Law in a jurisdiction. Such jurisdiction typically coincides with a certain geography, reigned by one, sometimes symbolical, supreme ruler or sovereign, whose face is often represented on the bills or coins making up the national currency, besides electronic versions of it.

The disadvantage of these currencies is Monetary Confusion, the root cause of the other four main disadvantages. Although the Objective Value of these National Currencies is fixed by legal force, the Subjective Market Value changes continuously based on the amount offered and demanded in the market. Since these fluctuations are not stabilized, given these

National Currencies are no longer exchangeable for gold, the Value of Money becomes unstable, causing Monetary Confusion and the five main disadvantages.

Legal Tender Currency

The Legal Tender Currency is the dominant currency in a jurisdiction that is imposed by legal tender law and therefore is in fact the same category as the previous category,

Contemporary National Currencies. Also supra-national currencies such as the Euro are part of this category. The disadvantages are the same.

Contemporary Banking Systems

Fiat Money, Legal Tender law and fractional reserve banking have led to the contemporary system of central banking. Central banking, Fiat Money and legal tender law are parts of the same system and therefore share the same disadvantages: Monetary Confusion and the five main disadvantages.

Historical and Contemporary Gold Certificate Currencies

Gold certificate currencies that are itself Physical Gold Money work quite well, but electronic transmission or paper transport of golden coins is only possible using an intermediate balance sheet, forcing contemporary gold currencies to be non-Physical Gold Money.

The balance sheet connecting a Value Certificate, such as gold certificate currencies and the actual gold asset remains liable to fraud, since the presence of physical goods, such as gold, cannot continuously and transparently be audited.

Pre-existing Complementary Currencies

Complementary currencies are already used in relative small communities in the US, Japan, the UK, Brazil, the Netherlands and Belgium. The disadvantage of these complementary currencies is that they do not hedge the risk of loss of Value better than the national currencies, because their Value is one to one linked to the national currencies. The disadvantage of Monetary Confusion and the other main disadvantages are therefore equally present with the pre-existing complementary currencies.

Pre-existing Virtual Currencies

Virtual currencies are currencies that are not certificates. There is no Objective basis for the Value, although there might be Market Value and Subjective Value as is the case e.g. with the Bitcoin money. It has no Intrinsic Value, only purely Subjective Value; therefore its Value is virtual.

The disadvantage of such virtual money is that when Subjective Value decreases, due to more Fear or Less Desire among members of the currency community, there is no Objective basis for Value in use, exchange or art to support the Value and therefore the Value can drop to zero overnight. It is therefore very bad Money. It does not protect against loss of Value in any way.

The Problem

Processing physical goods or intangible services in an economy requires exchanging these goods against one another or against an intermediate physical (tangible) or intangible means of exchange, while ensuring the value of the item traded for has substantially the same or similar value. If a good is traded against an intermediate means of exchange, i.e. money, not only should the first price reflect the value of the first good, and the other price(s) the value of the other exchanged good(s), but also—and this is the main problem—the value of the money itself should not be short term volatile or long term decreasing in order to allow the exchange of goods to happen effectively. If the value of the money is too volatile or long term loss of value occurs, the goods and services are less efficiently processed, or not processed at all. Periods in which goods are processed less efficiently or not at all result in economic bubbles, crashes, recessions, or depressions, and, in, extreme conditions, great depressions and hyperinflation periods, generally referred to as economic crises.

Summary of the Problematic Prior

The current state of the art is fiat money with fractional reserve. The objective value of such currency is fixed by law, that's why it is preferred to fiat money. Only a fraction of the intrinsic objective value of fiat money is determined by gold, the remainder is backed by government and private debt and other assets, typically not having an objective, intrinsic value, causing the subjective market value of the current fiat money to fluctuate volatilely and non-consistently within different branches of the economy. This is the root cause of monetary instability conditions such as inflation and deflation or disinflation, causing economic crises. The prior and current solutions to such conditions are to have central banking, providing liquidity, as the lender of last resort, to banks being subjected to loss of trust, or bank runs. However, restoring trust in the value of money is not necessarily accomplished by providing liquidity to distressed banks. Also, stimulating growth in the economy has been used as a way to restore trust in the value of fiat money, but such stimulation is not always possible or effective at all times. As such, the problems of the current state of the art of fiat money are: 1) monetary instability, 2) economic crises, and 3) inability to stabilize the value of money and vesting trust in the value of the money.

### SUMMARY OF THE DISCLOSURE

Disclosed is a new physical currency (and any electronic token of it), as well as its use in exchanging goods and a method for stabilizing its value by selecting the underlying stock portfolio (generally an asset having intrinsic value) and then having a central value bank directly or indirectly arbitrate the short term market value.

More specifically, a new and improved process to exchange physical, tangible goods as well as intangible services is proposed, based on a new form of money and a new banking system, featuring complementary central banking and banking, associating with saving and loaning the new currency. The new currency is complementary, meaning it does not replace the existing fiat currency, but may be used in addition thereto, in order to stabilize the fiat currency, its host currency, and prevent monetary instability in its host fiat currency. As such, the complementary new currency solves the problem of monetary instability in both the complementary new currency, as well as in the hosting fiat currency, preventing economic crises and restoring subjective trust in the value of money, and, therefore, in the monetary system. The new complementary currency may be implemented in any of physical, tangible and/or intangible electronic currency forms, as described herein.

FIG. 1 illustrates conceptually the relationship between physical goods and/or intangible services, the new complementary currency described herein and the equity portfolio substantiating such new complementary currency. In the illustrative embodiment, the new complementary currency may be issued the form of a certificate for value shares. A central value bank issues the complementary currency as publicly quoted share certificates of its own equity investment fund. These share certificates of the complementary central value bank can be wired or exchanged as paper or coins (possibly featuring an electronic chip) and are then used as currency, freely without legal tender law obliging acceptance of it.

The equity investment fund of the complementary central value bank comprises, in one embodiment, an equity stock portfolio guaranteeing long term value through safety margin between objective, intrinsic stock value and subjective market value. The equity stock portfolio that substantiates the value of the complementary new currency is a value stock portfolio, meaning it is picked or selected and reselected by choosing equity stocks that have relatively the best safety margin between objective, intrinsic value and subjective market value. The selection algorithms and their computer implementation are described herein.

In addition, the stock portfolio's foreign currency distribution is selected with the objective to hedge the foreign exchange risk and the risk of importing monetary instability from foreign currencies, as well as from the hosting fiat currency, and by choosing the currency distribution to reflect the currency distribution of the trade expressed in other currencies, as traded by the community using the new complementary value currency.

The short term risk of value loss is hedged by the central value bank arbitrating, directly or through its partnering market makers, between the market price of the new value currency (being the publicly quoted share certificates) and the intrinsic value of its own value currency. The intrinsic value of its value currency is modeled based on the market price of the underlying stock(s) in its stock portfolio or on the intrinsic value of such stock portfolio. Arbitrating between new value currency's market value and the intrinsic value based on the market value of the underlying stock allows for realization of arbitration profit, shared between partnering banks (restoring their balance sheets) and social non-profit organizations (as a free tax for social goals). In any case, the arbitration hedges the short risk of the currency and stabilizes the value of the currency, by steering it towards its intrinsic value. The information on market value, intrinsic value based on market value and/or intrinsic value of the underlying stock portfolio can be continuously communicated through electronic means, such as an smart chip embedded in physical, tangible money, allowing the trust to optimally build by having continuous transparency.

Collaborative loan and savings are achieved directly from the complementary central value bank. In order to guarantee 100% fraction and guarantee value substantiating money, saving are accepted by bank partners but converted into value currency and held directly on the balance sheet of the central value bank, from which loans are also originated.

The design rules, specifications for loans, savings and balance sheet structure of the central value bank, as well as the arbitration and stabilization methods and the stock selection methods, may all be implemented with a number of software algorithms which execute in conjunction with a decision engine and a plurality of predefined rules defining models for the new currency and central value banking system as disclosed herein.

The method and system described above processes physical and tangible goods more efficiently and more effectively. Concept of utilizing a volatile asset class, such as equity stock, to substantiate the intrinsic value of a new complementary currency is not obvious and novel. While the systems and methods described herein may be computer implemented the techniques also require skill and expert understanding in the fields of neuropsychology, history and economics. The integration of software, electronics, mechanics, economics, neuropsychology and history allows solving this technical problem of inefficiently (and sometimes even ineffectively) processing physical tangible goods in a practical manner.

In accordance with the foregoing, disclosed is a system and technique for establishing a Complementary Value Currency and a Free-Market Banking System. In accordance with the disclosure, Complementary Value Banking applies a set of Objective rules and processes, implementable as executable software embedded in a computer system, defining Complementary Value Banking. The Complementary Value Banking System consists of a Central Value Bank, Bank Partners also called Value Banks and a Community using the Value Certificates as Currency.

The Central Value Bank is a publicly quoted Value Fund, a fund holding and trading equity stock, optimizing its portfolio for maximal Safety Margin between Intrinsic Value and Market Value. The Central Value Bank's public stock functions as Money in order to be used by the Community as a Complementary Value Currency. Value Banks are commercial banks that partner with the Central Value Bank to broker the Value Currency, Saving Bonds as well as loans granted directly from the Central Value Bank's balance sheet.

The exchange rate of the Value Currency is the stock quote of the Central Value Bank. A stabilization procedure is disclosed that stabilizes the Market Value of the Complementary Value Currency, by arbitrating between Intrinsic Value and Market Value, through partnering Value Banks. The stabilization procedure also stabilizes the Legal Tender Currency and allows for stable restructuring of distressed commercial banks.

The fraction of Value Stock selected varies over Currencies regions, in order to hedge the risk of Monetary Confusion created by other currencies and therefore protecting the competitive strength of members of the Community.

The Complementary Value Banking System is implemented utilizing computer systems, and program products and methods in which the Value of money is Objectified, secured and stabilized by the Intrinsic Value of underlying assets of the Certificates used as Money through the Complementary Value Banking System.

According to one aspect of the disclosure, an article of manufacture for use as currency comprises: A) a token representation of an amount of value as an amount of currency; B) an underlying asset having an intrinsic value associated with the amount of currency; and C) a mechanism for substantiating the value of the currency with the underlying asset. In embodiments the mechanism for substantiating comprises any of a smart chip associated with the currency, a resolvable computer address embedded in the token representation of the currency, or an alert mechanism for indicating if the intrinsic value of the asset associated with the amount of currency has exceeded a predetermined threshold range of values.

According to another aspect of the disclosure, a method for transacting the exchange of goods/services comprises: A) providing an amount of goods or services having a value associated therewith; B) providing an amount of currency having an assigned value associated therewith, the currency further comprising a mechanism for substantiating the currency's value with an asset base having an intrinsic value, associated with the amount of currency; and C) exchanging the amount of goods or services for the substantiated amount of currency. In one embodiment, the further comprises: D) verifying that the traded value of the currency is substantially similar to the intrinsic value associated with the currency's asset base. In another embodiment, the method comprises: D1) confirming that a portfolio of at least one equity asset associated with the token representation of the currency has an intrinsic value at least substantially equal to the assigned value of the amount of currency.

According to yet another aspect of the disclosure, a method of preventing fluctuations in the value of currency, the method comprises: A) providing a representation of an amount of currency, the amount of currency having one of a numerical or nominative value; B) substantiating the value of the amount of currency with a portfolio of equity instruments, the amount of currency being a certificate of the intrinsic value of the portfolio of equity instruments; and C) utilizing one of a model of intrinsic value of the amount of currency or a model of intrinsic value of the equity instrument portfolio to hedge risks of diminishing value of the amount of currency.

According to still another aspect of the disclosure, a method for creating an equity portfolio comprises: A) from data stored in a network accessible memory, the data representing a plurality of equity instruments, each equity instrument associated with an entity issuing the equity instrument, computing for each equity instrument: i) an objective fundamental criteria, and ii) a subjective market criteria; B) eliminating the equity instrument associated with any entity having an associated value for the objective fundamental criteria and the subjective market criteria outside a predefined range of values; C) for each of the plurality of equity instruments, scaling a ratio of the computed value of the objective fundamental criteria to the computed value of the subjective market criteria by at least one weighting criteria so as to minimize risk; and D) retaining within the equity portfolio only those equity instruments resulting in positive weight values in C) above.

According to yet another aspect of the disclosure, a free-market banking system comprises: A) at least one network accessible central bank system comprising: i) a network interface; ii) at least one processor; iii) a memory for storing an executable equity portfolio model and a plurality of predefined rules associated with selection or trading of equity instruments and the issuance of currency, the currency; and B) a plurality of participating bank systems coupled over a network to the central bank system, each of the participating bank systems comprising a user interface for enabling automated and semi-automated interaction with the central bank system over a network.

### DESCRIPTION OF THE DRAWINGS

FIG. 1 illustrates conceptually the relationship between physical goods and/or intangible services, the new complementary currency described herein and the equity portfolio substantiating such new complementary currency;

FIG. 2 illustrates conceptually a network environment in which the Value Banking System disclosed herein may be implemented;

FIG. 3 illustrates conceptually system architecture, respectively in which the system disclosed herein may be implemented;

FIG. 4A-B illustrates conceptually data structures useful in implementing the new complementary currency and free-market banking system in accordance with the disclosure;

FIG. 5 is a conceptual graph illustrating the transient behavior of the Subjective market price, converging in the long run to Intrinsic Value;

FIG. 6 is a conceptual graph illustrating the Money Price Stabilization Procedure, using its Intrinsic Value to arbitrate the market price of Money and aligning the Money Supply with the Money demand;

FIG. 7 is a conceptual diagram illustrating the transactional flow between Money and Value of the Value Banking System's Central Value Bank's balance structure according to the disclosure;

FIG. 8 illustrates a flow diagram of a Safety Margin algorithm in which the Value Stock selection by the Central Value Bank in the Value Banking System disclosed herein may be implemented; and

FIG. 9 illustrates a graph of an efficient stock market where the market priced profit equals the Objective Profit as disclosed herein.

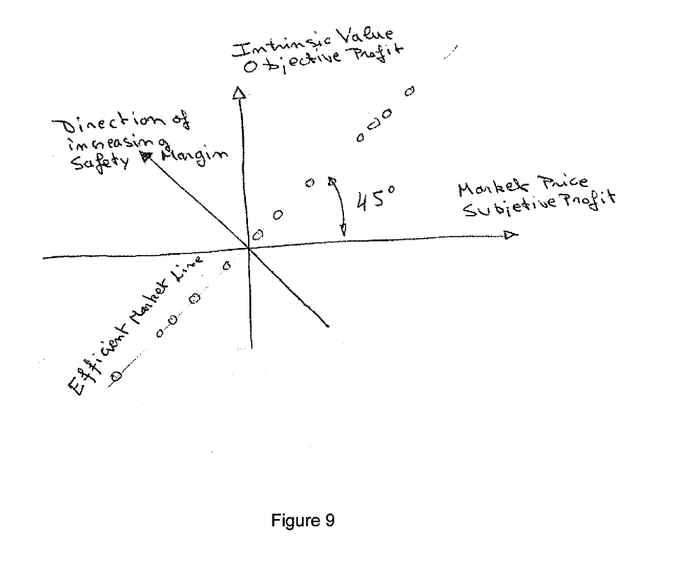

### DETAILED DESCRIPTION

Definitions and Concepts

The following terms and phrases as used herein have the definitions described below, in addition to other relevant interpretations thereof.

Financial Crisis—A crisis caused by the financial system or the bank system, such as a recession or depression. The Great Depression of the last century's thirties, as well as the current financial crisis are constitutive or inductive examples that formed the concept of a Financial Crisis.

Monetary Confusion—The confusion between the variation of the Value of a good and the variation of the Value of Money used to express the Value of the good, as its price.

Free-Market Banking System—A Free-Market Banking System is a banking system in which interests on savings and loans are freely determined by the market without government intervention and where Money can freely compete to become the (most popular, or most current) Currency.

Money and Currency—Money is a means of storing and exchanging value, enabling barter trades within a community to be executed in the absence of the actual goods involved in the barter. Money that is actively and fluently used in a community becomes a Currency. Money is individually used by humans to store Value over time and collaboratively by a community, as a Currency, to exchange Value.

Value Certificate—Value Certificates consist of electronic, paper, metal or other tokens of the right to value, typically the right to participate in the partial or full liquidation of assets held on the active side of a balance sheet, where the passive of that balance sheet consists of those Value Certificates.

Certificate Money—Certificate Money consists of Value Certificates that are individually used as Money to store Value over time and collaboratively by a community, as Currency, to exchange Value.

Value Banking System—A Value Banking System is a banking system in which the Money consists of Value Certificates backed by Value Stock.

Value Stock—Value Stock is equity stock in an enterprise (en entrepreneurial activity with the aim to create Value) that has maximal Safety Margin between Objective Intrinsic Value and Subjective Market Price.

Metal Money—Metal Money is made of metal. The metal can be the actual valuable asset providing Value to Money or just be a token of it, as Certificate Money.

Physical Gold Money—Non-Certificate Metal Money, where the metal is gold.

Gold Certificate Money—Certificate Money where gold is the asset on the active side of the balance sheet, of which the Value Certificates represent the passive.

Complementary Currency—A Complementary Currency consists of Certificate Money that is freely used by a community or a subdivision of a community, as a currency that runs in parallel to the existing Legal Tender Currency.

Legal Tender Currency or Fiat Money—The Legal Tender Currency is the dominant currency of a jurisdiction that is imposed by legal tender law. The legal tender law fixes the

Nominal Value of Fiat Money, having caused it in history to be the Currency of the community dominated by that jurisdiction.

Nominal Value—The Nominal Value of Certificate Money is the Objective Value determined by the name (in words) and the amount (in numbers) displayed on Certificate Money. The name and number can also be united in one figure, as the face of the issuer (or someone else the issuer chose).

Complementary Value Currency—A Complementary Value Currency is a

Complementary Currency that consists of Value Money.

Value Money or Currency—Value Money or a Value Currency consists of Certificate Money that is a token of participation in assets with Intrinsic Value that are acquired with application of a Safety Margin.

Intrinsic Value—Intrinsic Value of an Object is the Objective Value of that Object that is logically derived as a necessary characteristic of that language Object, resulting from the definition of that Object and a formally and logically correct deductive reasoning.

Safety Margin—A Safety Margin is the margin of safety that exists between the higher Objective Intrinsic Value of a Good and the lower Subjective Market Price at which that Good is acquired.

Object—An Object is a mental projection emerging from networked neuronal firing that is logically and/or numerically consistently interpretable by a different Subject than the Subject that expressed it in language and/or numbers. Most mental projections are not entirely Objective. People tend to believe or assume that there remains a residual non-consistency between mental projections in different Subjects. The Object is therefore a reduction of the mental projection, called notion, concept or idea.

Left Brain Consciousness—The Left Brain Consciousness is the consciousness that emerges from the entire brain, under the direction of the left pre-frontal cortex. Since Language is (in the vast majority of human brains) directed from the same left pre-frontal cortex, Left Brain Consciousness is also defined as language consciousness or Objective consciousness. In language consciousness, the law of non-contradiction is tautologically valid, creating a one dimensional consciousness between positively affirming a language statement and negating it, expressed in the logical formulation of the law of non-contradiction as (+p)+(−p)=0.

Subject—A Subject is a mental projection that is not (yet) entirely logically and/or numerically reducible in Objects, without residual non-consistency or Bivalence. A raw or total Subject contains conscious as well as sub- or pre-conscious information on phenomena and therefore also includes all known Objective dimensions. A pure or remaining Subject contains only the residual non-consistency that hasn't yet been logically and/or numerically consistently interpreted in objects. Human beings, as well as animals, are classical constitutive or inductive examples that formed the concept of a Subject, also referred to as a spirit or psyche. The word Subject not only means a human or other living being, it means also the Subject of a sentence, as well as the Subject as the topic of a writings or conversations, as in the Subject or topic of a scientific discipline, meaning the total field of knowledge of certain phenomena.

Right Brain Consciousness—The Right Brain Consciousness is the consciousness that emerges from the entire brain, under the direction of the right pre-frontal cortex. The

Right Brain Consciousness empathically integrates phenomena into images and Subjects, to induce concepts, invent ideas or intuitively visualize meaning as a notion. While the Left Brain Consciousness is analytically reducing and differentiating phenomena from all over the brain into Objects, the Right Brain Consciousness is intuitively integrating phenomena over the entire brain into Subjects, meaning and sense.

Value—A Subjective image in the Right Brain Consciousness that intuitively shows how much appreciation a Subject or person would feel for an Action taken (such as a good or favor delivered) by another Subject or person.

Knowledge—Knowledge is the name of Subjective and/or Objective representations of conscious as well as sub- or pre-conscious information on phenomena.

Science—Science is the collective human endeavor to analyze or reduce the abstract Subject of certain phenomena into differentiated Objects. Individually it primarily emerges from the Left Brain Consciousness, although Science is the result of a combined, but not necessarily simultaneous, activity of the Left and Right Brain Consciousness. Science is created when Subjects in the Right Brain Consciousness are reduced to Objects in the Left

Brain Consciousness, which allows the Left Brain Consciousness to detect contradiction with existing (formal) memory of phenomena and new (empirical) phenomena to exclude wrong knowledge and further reduce the Subject into Objects.

Bivalence—Bivalence is the Objective name I gave to the Subjective concept, notion or idea of phenomena being both Subject and Object at the same time, because the Right

Brain Consciousness and the Left Brain Consciousness exist simultaneously when humans are conscious of phenomena. Being is fundamentally Bivalent, since human consciousness is bivalent, because the brain is bilateral. The equivalence of matter and energy in physics is just one, albeit a very convincing example of my Subject-Object and Left-Right Consciousness Bivalence concept or hypothesis.

Transcendence—Transcendence is the Objective name given to the Subjective concept, notion or idea of phenomena not being reducible to Objects only, unless the phenomenon is a pure tautological mental projection or pure Object. A pure Subject is irreducible to nothing (unless it's a pure Object, but then it is no Subject), so being remains Transcendent to language (and numbers). Residual measuring inaccuracy is an example of Transcendence.

Cult or symbolic religion—A cult or a symbolic religion is a collaborative human endeavor to intuitively synthesize phenomena into a (and eventually the) total Subject. Individually it emerges from the activity of the Right Brain Consciousness.

Culture—Human Culture is the combination of Cult and Science in their pure and mixed forms.

Free Will—Free Will is the Objective name given to the Subjective concept of Transcendence in understanding human behavior. Free Will is defined as the residual non-consistency, remaining after neurological, psychological, sociological and other Objective reductions of the scientific Subject of free human behavior.

Free Human Action—Free Human Action is the Subjective result of human Free Will.

Free Human Action (as well as free animal Action) is the pure Subjective source of real change. It is not (yet) deterministically reducible to Objective causes of change, such as heat, mechanical force, post-natal depression or lack of dopamine.

Free Human Action is defined as free, outside family and between families human behavior. One person families qualify as well as family.

Economics—Economics is the scientific discipline that tries to further reduce the Bivalence in Free Human Action. The Subject of Economics is Free Human Action, resulting from Free Will. Contrary to Psychology, Economy does not Objectify Free Will, but only Free Human Action.

Psychology—Psychology is the scientific discipline that aims at further reducing

Bivalence in the Human Subject or psyche itself. The Subject of Psychology is the psyche. The endeavor is to further objectify and thus reduce the psyche in Objects such as Motivation, Emotion, sub- and pre-conscious projections and representations and finally name the remaining Subject Free Will. Therefore the Free Will, as well in Psychology as in Economics, remains the residual inconsistent, unreducible and therefore Transcendent Subject.

Motivation—Motivation is the Subjective source of immediate Action.

Emotion—Emotion is the Subjective source of future Action.

Fear—Fear is the Objective name for the generalized Subjective Emotion with negative valence. Fear is the Subjective force Objecting change.

Risk—A Risk is an Objectified Fear, grounded in Objective reality and expressed in language and/or numbers.

Desire—Desire is the Objective name for the generalized Subjective Emotion with positive valence. Desire is the Subjective force creating change and Subjecting to change. Also this word Subject, in ‘to subject’, is the same word Subject as in the concept and definition of Subject described and it has the inverse meaning of the word Object in ‘to object’.

Good—The adjective Good is used in a specific sense, not as a Subjective judgment of Value, but as an Objective adjective indicating that the specific character of the noun contributes to human specie's evolutionary fitness for survival.

Complementary Value Money—has an Objective structure that is the same structure that contributed to mankind's fitness for survival: dealing Objectively with Fear. Therefore it will probably also contribute to mankind's further fitness for survival. Therefore it is called Good Money, rather than good money.

System Implementation

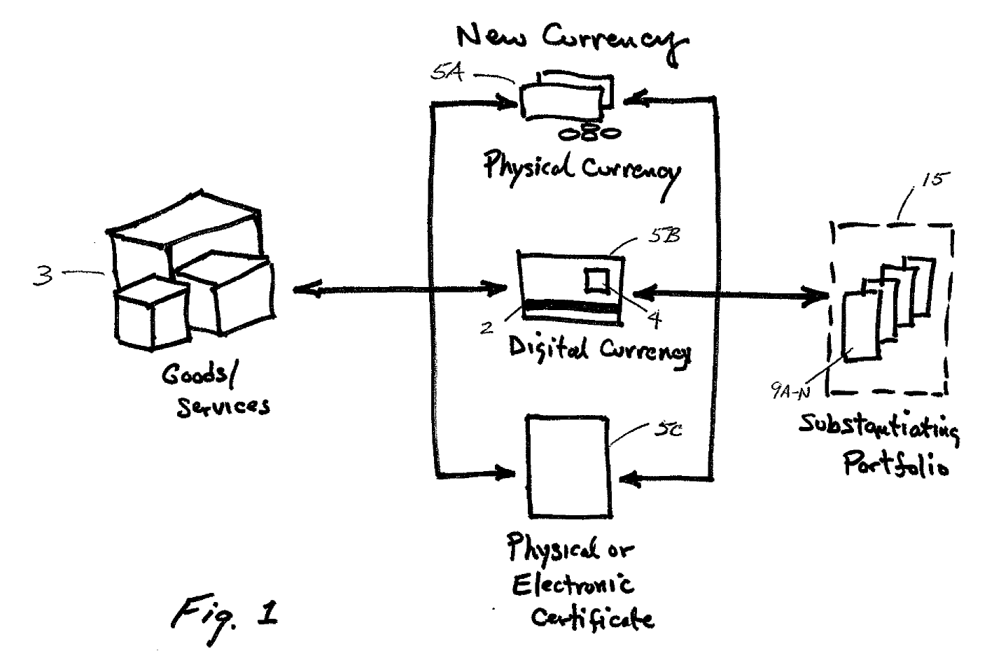

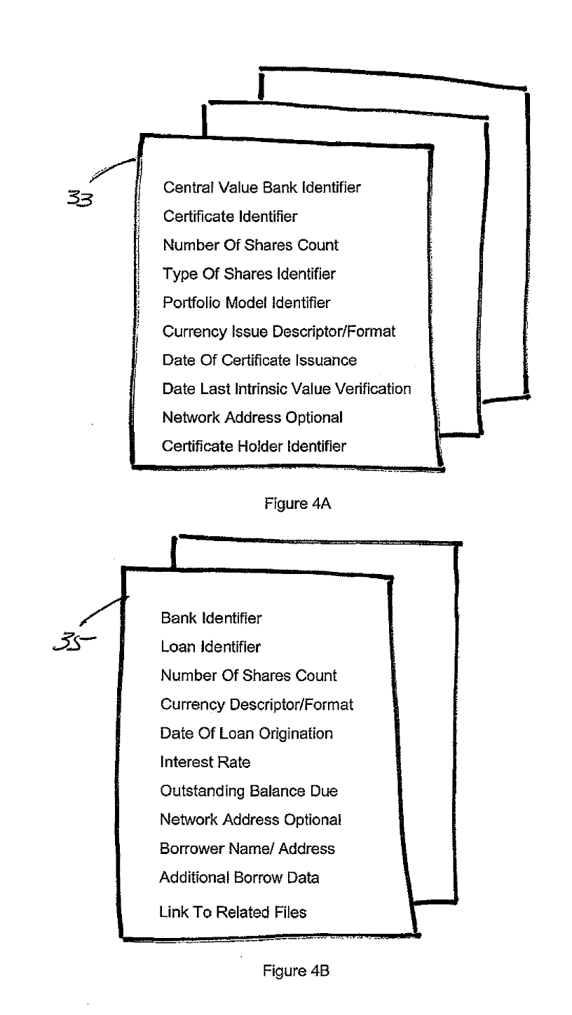

As noted previously, FIG. 1 illustrates conceptually the relationship between physical goods/intangible services 3 (hereafter goods), the new complementary currency 5 described herein and an equity portfolio 15 substantiating such new complementary currency. Specifically, goods 3 may comprise any tangible items or services which have value and may be exchanged or processed for a form of the new complementary currency 5 whose value is maintained stable by equity portfolio 15 in accordance with the new value banking system disclosed herein. New complementary currency 5 may take the form of physical notes or coins 5A, or a physical apparatus 5B, or a physical or electronic certificate 5C. The currency 5 in the form of physical apparatus 5B may be implemented as a currency token which, in one embodiment, may be substantiated with a smart card having one or both of a magnetic strip 2 or smart chip 4 embedded thereon for communicating with any of the systems 10 within the new value banking system. Magnetic strip 2 or smart chip 4 may be utilized as links or communication mechanisms to substantiate or verify the value of the currency with the value banking system. Certificate 5C may be in the form of a physical certificate, such as a traditional stock certificate or may be an electronic certificate stored in a computer memory and having a data structure associated therewith similar to that described in FIG. 4A herein. Equity portfolio 15, as described elsewhere herein, may be comprised of a plurality of individual equity instruments 9A-N. As explained elsewhere herein, equity portfolio 15 and its constituent equity instruments are selected based on a model and one or more associated rules which are used to collectively implement in an automated manner the bylaws of the new value central bank. The equity portfolio 15 provides the underlying asset basis for the amount of value of the currency as issued.

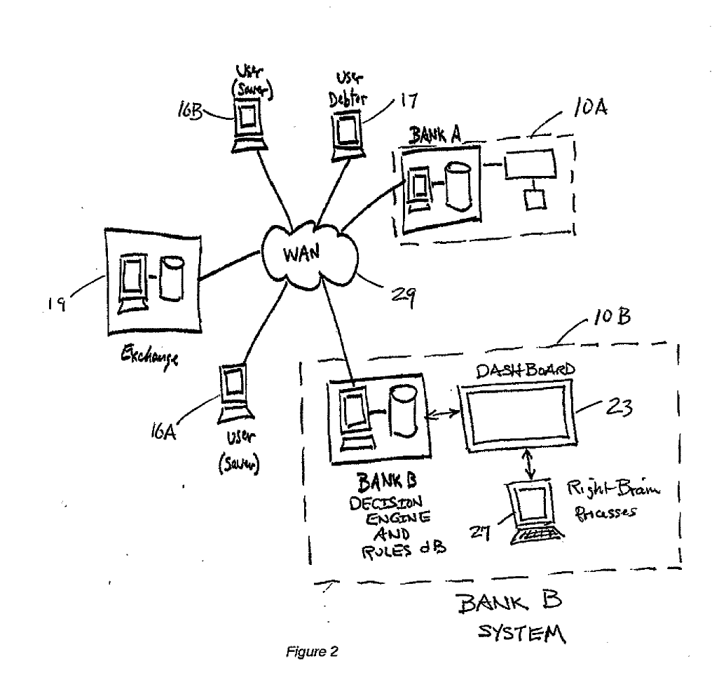

FIG. 2 illustrates a network environment in which a free-market banking system in accordance with the disclosure may be implemented. As illustrated in Figure, bank systems 10A-B, users 16A-B representing savers, user 17 representing a debtor, as well as exchange 19 are all interconnected via a computer network topology 29, typically a combination of LAN and WAN networks, i.e. the Internet, to facilitate electronic financial transactions. Note that at least one of bank 10A or bank B are part of the free-market bank system described herein, operating in accordance with the bylaws incorporating the free-market bank protocol. Such protocol may be implemented with a series of computer algorithms and threshold values which are stored by the bank the form of a collection of rules which may be acted upon by a decision engine and utilized in conjunction with the banks various day-to-day procedures and decisional processes as it transacts business. FIG. 2 further illustrates that each of banking systems 10A-B may comprise one or more additional computer systems 27, databases and servers 37 and/or dashboard displays 23.

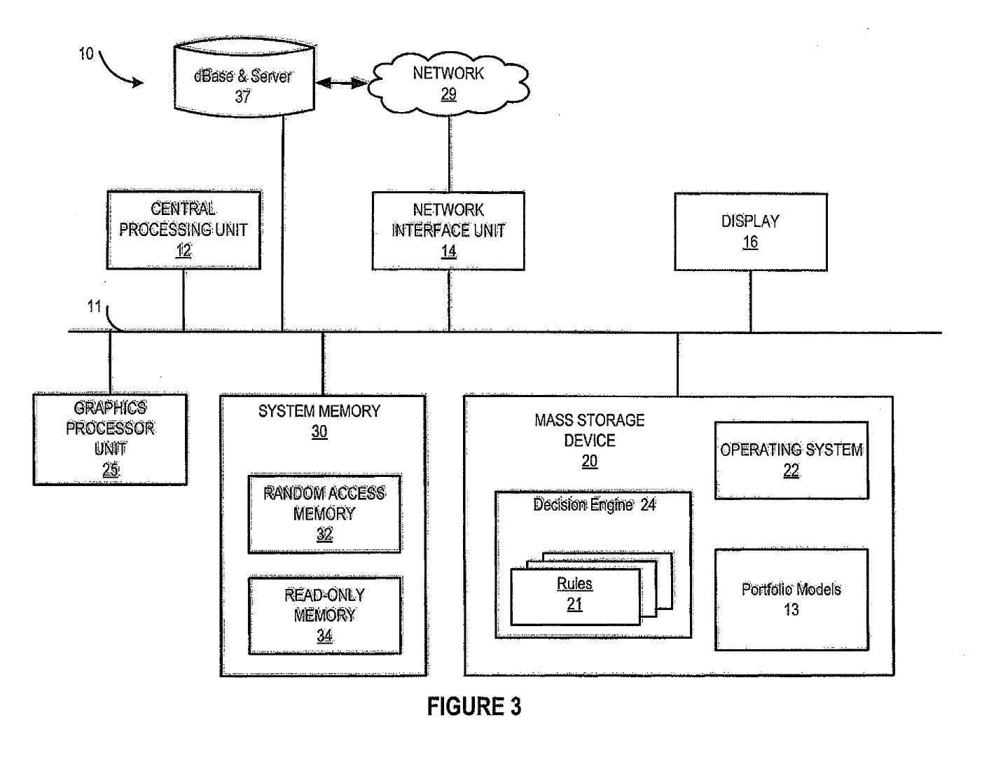

FIG. 3 illustrates conceptually a computer architecture 10 which may be implemented any of the systems illustrated in FIG. 2 to perform methods described. Hs illustrated in FIG. 3, computer architecture 10 comprises a central processing unit 12 (CPU), a system memory 30, including one or both of a random access memory 32 (RAM) and a read-only memory 34 (ROM), and a system bus 11 that couples the system memory 30 to the CPU 12. An input/output system containing the basic routines that help to transfer information between elements within the computer architecture 10, such as during startup, can be stored in the ROM 34. The computer architecture 10 may further include a mass storage device 20 for storing an operating system 22, data and various program modules, such as the decision engine 24, rules 21 and portfolio models 13.

The mass storage device 20 may be connected to the CPU 12 through a mass storage controller (not illustrated) connected to the bus 11. The mass storage device 20 and its associated computer-readable media can provide non-volatile storage for the computer architecture 10. Although the description of computer-readable media contained herein refers to a mass storage device, such as a hard disk or CD-ROM drive, it should be appreciated by those skilled in the art that computer-readable media can be any available computer storage media that can be accessed by the computer architecture 10.

By way of example, and not limitation, computer-readable media may include volatile and non-volatile, removable and non-removable media implemented in any method or technology for the non-transitory storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the computer architecture 10.

According to various embodiments, the computer architecture 10 may operate in a networked environment using logical connections to remote physical or virtual entities through a network such as the network 29. The computer architecture 10 may connect to the network 29 through a network interface unit 14 connected to the bus 11. It will be appreciated that the network interface unit 14 may also be utilized to connect to other types of networks and remote computer systems. In one embodiment, network interface 14 includes the necessary transceiver hardware (not shown) to communicate wirelessly with other network devices or processes. The computer architecture 10 may also include an input/output controller for receiving and processing input from a number of other devices, including a keyboard, mouse, or electronic stylus (not illustrated). Similarly, an input/output controller may provide output to a video display 16, a printer, or other type of output device. A dedicated graphics processor 25 unit may also be connected to the bus 10.

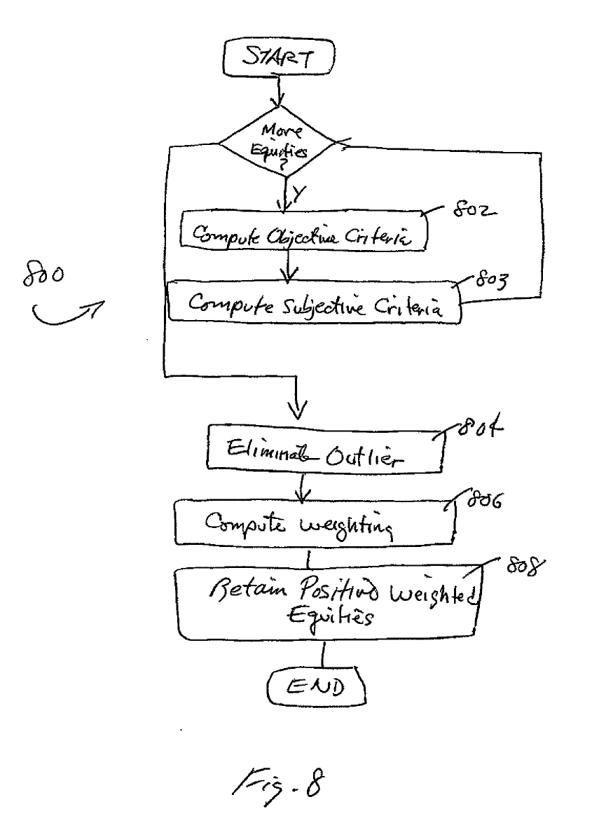

As mentioned briefly above, a number of program modules comprising sequences of executable instructions, and data files may be stored in the mass storage device 20 and RAM 32 of the computer architecture 10, including an operating system 22 suitable for controlling the operation of a networked desktop, laptop, server computer, or other computing environment. The mass storage device 20, ROM 34, and RAM 32 may also store one or more program modules. In particular, the mass storage device 20, optionally in conjunction with RAM 32, may store the executable instructions that program modules comprising decision engine 24 for execution by the CPU 12. The decision engine 24 can include software components for implementing portions of the processes discussed in detail with respect to FIG. 8 as well as the other computational communication properties described herein 10. According to embodiments, the decision engine 24 may also be stored on the network 29 and accessed by any computer within the network 29. Also patent database 37 and its accompanying server process may be coupled directly to the bus 11 of system 10 or may be remotely connected thereto via network 29.

The software modules may include software instructions that, when loaded into the CPU and executed, transform a general-purpose computing system into a special-purpose computing system customized to facilitate all, or part of, the volatility index generation techniques disclosed herein. As detailed throughout this description, the program modules may provide various tools or techniques by which the device or computer architecture may participate within the overall systems or operating environments using the components, logic flows, and/or data structures discussed herein.

The CPU 12 may be constructed from any number of transistors or other circuit elements, which may individually or collectively assume any number of states. More specifically, the CPU 12 may operate as a state machine or finite-state machine. Such a machine may be transformed to a second machine, or specific machine by loading executable instructions contained within the program modules. These computer-executable instructions may transform the CPU 12 by specifying how the CPU 12 transitions between states, thereby transforming the transistors or other circuit elements constituting the CPU 12 from a first machine to a second machine, wherein the second machine may be specifically configured to manage the generation of portfolios and/or decisions. The states of either machine may also be transformed by receiving input from one or more user input devices associated with the input/output controller, the network interface unit 14, other peripherals, other interfaces, or one or more users or other actors. Either machine may also transform states, or various physical characteristics of various output devices such as printers, speakers, video displays, or otherwise.

Encoding of executable computer program code modules may also transform the physical structure of the storage media. The specific transformation of physical structure may depend on various factors, in different implementations of this description. Examples of such factors may include, but are not limited to: the technology used to implement the storage media, whether the storage media are characterized as primary or secondary storage, and the like. For example, if the storage media are implemented as semiconductor-based memory, the program modules may transform the physical state of the system memory when the software is encoded therein. For example, the software may transform the state of transistors, capacitors, or other discrete circuit elements constituting the system memory.

As another example, the storage media may be implemented using magnetic or optical technology. In such implementations, the program modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. It should be appreciated that various other transformations of physical media are possible without departing from the scope and spirit of the present description.

FIG. 4A illustrates conceptually a data structure 33 which may be stored by the Central value Bank 10B in association with a particular value share certificate representing the new value currency in accordance with the disclosure. Specifically, data structure 33 may be implemented as an object, record, file or other storage construct maintainable in accessible memory and may comprise one or more fields or parameters which help identifying the particular instance of new currency. Such fields or parameters may be utilized to identify one or more of the following self-explanatory parameters:

### Bank Identifier

### Certificate Identifier

### Number Of Shares Count

### Type Of Shares Identifier

### Portfolio Model Identifier

### Currency Descriptor/Format

### Date Of Certificate Issuance

### Date Last Intrinsic Value Verification

### Network Address (Optional)

### Certificate Holder Identifier

A plurality of data structures 33, each in association with a certificate of shares of new currency, may be stored in database 37 or other memory of a New Value Bank system 10 in accordance with the disclosure.

In a similar manner, FIG. 4B illustrates conceptually a data structure 35 which may be stored by the Central value Bank 10B in association with a loan or promissory note in accordance with the disclosure. Specifically, data structure 35 may be implemented as an object, record, file or other storage construct maintainable in computer memory and may comprise one or more fields or parameters which help identifying the particular instance of new currency. Such fields or parameters may be utilized to identify one or more of the following self-explanatory parameters:

### Bank Identifier

### Loan Identifier

### Number Of Shares Count

### Type Of Shares Identifier

### Portfolio Model Identifier

### Currency Descriptor/Format

### Date Of Loan Origination

### Interest Rate

### Outstanding Balance Due

### Network Address Optional

### Borrower Name

### Borrower Address

### Additional Borrow Data

### Link To Related Files

A plurality of data structures 33, each in association with a certificate of shares of new currency, may be stored in database 37 or other memory of a New Value Bank system 10 in accordance with the disclosure.

Economics Theory Based on Evolutionary Neuropsychology and Cultural History Subjective and Objective Value

Value, whether moral or economic, is a Subjective Right Brain projection that remains transcendent to Objective reduction in language and figures. While fundamentally Subjective, Value can also be Objective, when it is expressed in language and/or numbers.

Value is, as any other Right Brain projection, relative. Something is judged by a Subject more valuable than something else.

Intrinsic Value however is Value that is not judged by a Subject and therefore entirely Objective. Intrinsic Value is a property of the Object itself. Few Objects have intrinsic Value. Intrinsic Value only exists, if the Value is a logical property of the language Object itself.

Intrinsic Value can be expressed in language, only when the Value is tautologically intrinsic to the definition of the object, or when it can logically consistently be derived from that definition. Such as in: ‘the Intrinsic Value of a Value creating entity (an enterprise, or entrepreneurial activity) is the Value it creates’ or in: ‘the Intrinsic Value of a Value Certificate is the Value of the assets it represents’ or as in: ‘the Value of a bill of one dollar is one dollar’.

When not intrinsic, Value cannot exactly be measured, without measuring uncertainty. That is not only true for economic Value, but for the Value of any non-tautological Object in any dimension.

Market Value and Price

The Market Value is the momentary Subjective Value attributed to an Object when it is traded on a market, by the Subjects participating in that market.

The Market price is the Objective expression of this Subjective Market Value. It is expressed in a currency and therefore the market Value of that currency equally contributes to the market price, as the market Value of the good does.

The Market Value is Subjective, but can incorporate Objective parts, when a certain factor or rationale influencing the price can be deterministically modeled.

The Intrinsic Value of equity stocks or Certificate Currencies forms the Objective part of their Subjective Market Value, the remainder is the purely Subjective part. It is determined by Fear and Desire interacting with the Free Will of the participating members of the market. Given the fluctuations of Desire and Fear, the pure Subjective part of the Market Value fluctuates most. Also the fluctuation of the Subjective Market Value of the Currency, in which the Market Value of the good is expressed, is an equally important contributor to any price volatility.

The Market Value, as anything else, is therefore composed of an Objective part and a purely Subjective part. The aim of the science of investing, as of any other science, is to reduce the Subjective part into Objective parts.

The Market Mechanism Tests Objective Knowledge of Value in Market Prices

A key insight of Popper on the scientific method is that Objective knowledge on a certain scientific Subject grows and becomes more accurate when more empirical tests proof current Objective knowledge to be false and when the current hypotheses are replaced by new conjectures that are Objectively formulated and that resist falsification in new experiments, meaning they are corroborated by empirical experiments.

In the same way it is a key insight on the market mechanism that Objective knowledge of the Subjective Value of a good grows and becomes more accurate when more market tests proof current Objective knowledge to be false and when the current price is replaced by newer prices that better resist falsification in new market tests, meaning the price is corroborated in the market.

This growth of knowledge of the Value of a good, converges to the Objective Intrinsic

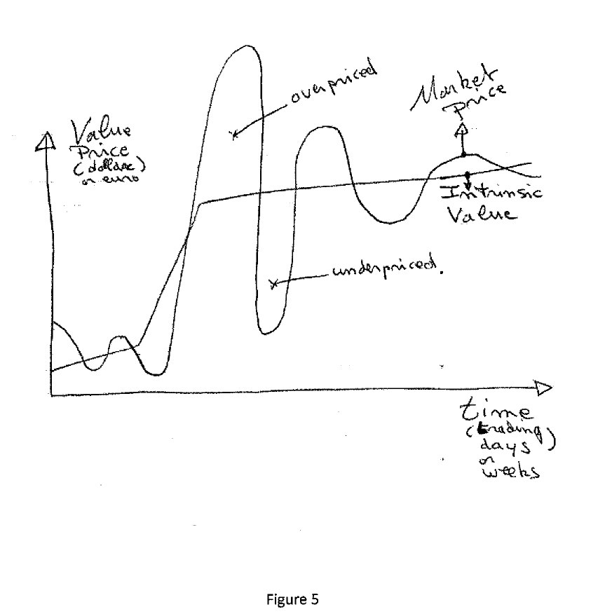

Value of that good, when 1) such Intrinsic Value exists and 2) the variation of such Intrinsic Value during the duration of the transient behavior is substantially smaller than the range of such transient behavior, as illustrated in FIG. 5.

The range and duration of the transient behavior is a function of purely Subjective factors and is therefore not fully reducible in Objective knowledge. Meaning e.g. that the duration of the ‘long run’ in Keynes notorious ‘In the long run we are all dead’ is unknown.

Summarized, it means that the Market Value converges to the Intrinsic Value over the long run, if such Intrinsic Value exists and does not vary substantially over that same long run.

Money

Money is the Object that Culturally evolved to hedge the Fear for loss of Value over time, whether the Money is saved or exchanged. The more Objective Money is, the better it protects against loss of Value, the more successful it supports a community.

Therefore hedges Good Money Objectively the risk of loss of Subjective Value over time.

When members of a community Subjectively trust Money to be Good, this Money becomes a Community Currency.

Variability and Stability of the Market Value of Money

The Market Value of any good, as well as Money is variable, based on demand and offering in the market, itself determined by the relative Subjective valuing of goods and Money, depending on the Fear of not possessing the good (e.g. food), the Desire for the good (e.g. an iPad) and the expected future Value of the good (e.g. fish) and Money (cf. Monetary inflation).

The Value of Physical Gold Money was relatively stable thanks to people initially not Fearing lack of gold, but sufficiently Desiring gold (it makes great art), making the Subjective factors Objectively determining the Value of gold quite stable. Therefore Physical Gold Money delivered quite stable Value as a Currency, without gold having Intrinsic Value. Still Physical Gold Money would vary Subjective Value based on offer and demand of Money and goods in the market. The saving or re-minting into new Currency stabilized this subjective Value fluctuations and Physical Gold Money became the best money of the state of the art, so far.

Non-Physical Gold Certificate Money was recurrently liable to fraud. The stable Value of gold did not itself hedge the risk of the gold not actually being present to back the certificate. As King Charles I of England and the subsequent goldsmiths proved.

The continuously changing Value of Certificate Money is stabilized by the stability of the Market Value of the assets the Certificate Money represents. At least if Subjective trust in their ability to exchange the currency for its underlying Value. Transparent auditability of a balance sheet is a condition for Subjective trust in that balance sheet, also the balance sheet of a Value Certificate, such as Certificate Money. The actual presence of the assets underlying the Value Certificate used as Money, should be reliably auditable, to enable the Subjective trust among Community members to, that their Money system is not fraudulent.

Monetary Inflation and Hyperinflation

When the Market Value of Money fluctuates and cannot be stabilized by the more stable Market Value of the assets underlying the Certificate, the Value of Money becomes unstable.

E.g. when more Money is brought into circulation, without the Value being exchanged in this Currency increasing, the Subjective Market Value of the Money decreases. The Value of the Money can be stabilized by decreasing the amount of Money through its exchange for the stable Valued asset underlying the Currency, e.g. by melting golden (or other precious metal) coins for different use, or re-minting them in a different Currency. When the Value of Money is not stabilized by exchanging it for the underlying assets, reducing the amount of Money, the Value of Money remains decreased and Monetary Inflation occurs.

When the relative Subjective Value of the underlying assets decrease, such as is the case when large gold quantities are mined or discovered, Monetary Inflation emerges as well, as Friedman has shown from history. When the decrease of Value of the currency is abrupt, Monetary Inflation is called Monetary Hyperinflation.

Monetary Confusion, Recessions and Great Depressions

When the Market Value of Money changes continuously, because it cannot be stabilized by the assets underlying the Certificates used as Currency, the changing Value of goods becomes confusing to entrepreneurs as to any other participant in the market.

A participant in a market uses the price signals to sell more and possibly produce more or buy more and possibly consume or invest more. Price signals are confused by the instability of the Value of Money. This phenomenon is referred to as Monetary Confusion, being the confusion between a change in Value of a good and a change in Value of the Money used to trade the good.

When interest rates are artificially manipulated by central banks, the expected Value of Money in the future becomes very uncertain and market participants are confused, interpreting price signals, resulting in over or under investment, manufacturing and consumption. The economic cycles featuring bubbles or booms and crashes or recessions, are an immediate result of Monetary Confusion. Extreme cases of Monetary Confusion paralyzing investment and dramatically reducing consumption cause Great Depressions.

Good Money

Money is the Object that hedges the Fear for loss of Value over longer time in savings as well as shorter time as currency. Good Money does that well. Objects have neuropsychologically, evolutionary evolved to deal with Fear. Therefore for Money to be Good Money, it should have Objective Value.

Government and private debt has no Objective Intrinsic Value but an unstable

Subjective Market Value only. Fiat Money backed by debt does therefore not secure Value over longer time. The Subjective Market Value of Fiat Money based on debt without Intrinsic Value is not stabilized Value over short term, e.g. by saving or reminting, either. Therefore the contemporary Fiat Money does not secure Value over shorter neither longer time and is really bad Money. It causes Monetary Confusion, economic cycles, recessions and depressions.

Physical Gold Money has worked quite well as Money, because the Subjective Value of gold is relatively stable and it is further stabilized through its property of being infinitely remeltable without loss, although gold has no objective Value. Physical Gold Money is the best money of the prior art, but still is no Good Money. The Spanish inflation in the 16^{th} century, resulting from a massive overseas inflow of precious metals proves it.

Non-Physical Gold Money has the problem of lack of continuous and transparent auditability and is therefore liable to fraud. Therefore it is not Good Money either.

The invention described is Good Money. In order to be Good, Money should have

Objective Value and in order to be a Good Currency it should as well enjoy Subjective trust among the members of the community. The Objective Value of the Money described here results from the Intrinsic Value of a Value Stock Portfolio used as the asset underlying the Certificate used as Money. The continuous and transparent auditability of a public stock portfolio is Objectively trustworthy and therefore allows for building of Subjective trust among the members of the community using the Money as Currency.

Value Banking System

Disclosed is a method and procedure for a Complementary Value Banking System, embedded in software, securely exchanging and storing saved Value over time in money and savings bonds enabling trustworthy exchange of Value through its community currency.

Complementary Community Currency

Disclosed is also a method to allow Subjective trust in the Banking System and its Currency to grow among the members of the Currency Community. This Community Currency is freely and voluntarily chosen by members of the community and is Complementary to the Legal Tender Currency.

Value Certificate Acting as Money

The Central Value Bank is a publicly quoted investment fund. The publicly quoted shares of the fund are the Certificates that are Good Money and therefore are used as Community Currency.

The publicly quoted shares of the fund are the Value Certificates or the Money, the stock quote form the exchange rate. The continuous publicly trading of the Money allows for the continuous exchange for other currencies, allowing the Subjective trust to grow and the Objective stabilization mechanism to be executed, under direction of the Central Value Bank.

Value Money Supply, Money Price Stabilization and Bank Partner Arbitration

Capital or Value is brought into the Central Value Bank by Community members or savers seeking trustworthy money when they buy Value Money and use it as Value Currency or to buy Value Saving Bonds.

Bank Partners, also called Value Banks, broker the Value Currency to Community members by arbitrating the Value Currency in the market. Therefore Value Banks are allowed, from time to time, at discrete moments in time determined at the discretion of the Central Value Bank, to buy Value Money from the Central Value Bank at a premium to the Money's Intrinsic Value (determined by the Market Value of the Value Stock Portfolio), only when the Market Value of the Value Currency is above its Intrinsic Value and subsequently sell it at the higher market price, decreasing the Money market price. And similarly to sell Value Money at a discount to its Intrinsic Value, only when its Market Value is under its Intrinsic Value, while buying it at an even lower market price, increasing the Money market price_{—} The continuous swing of the market price around its Intrinsic Value is stabilized by this

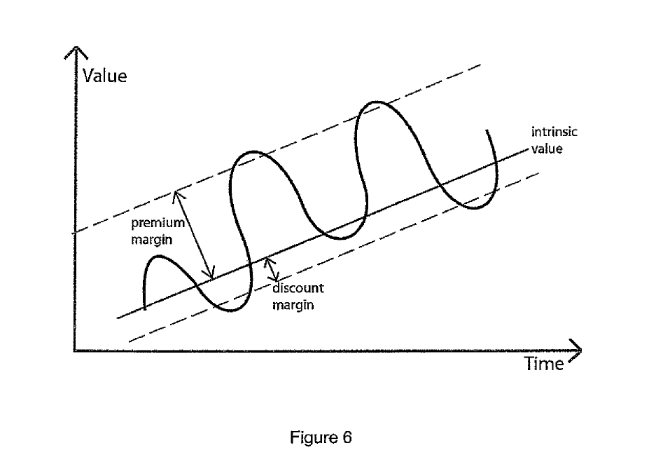

Stabilization Procedure, as indicated in FIG. 6.

The profit made by selling Value Money at a premium to its Intrinsic Value to Value Banks flows back to the Currency Community, as described further. The profit Bank Partners make by buying Value Money at a discount to Market Value and selling it at Market Value is used by Bank Partners to repair their balance sheets, which are typically damaged by government debt or other toxic assets. Similarly with profit made when Bank Partners buy Value Money at Market Value, below its Intrinsic Value and sell it to the Central Value Bank at a discount Intrinsic Value that is still higher than the Market Value.

This arbitration by Banking Partners aligns the money supply to the demand for money, using the pricing mechanism of the free market.

Hedging the Long Risk of Value Loss

Securing Value over longer time is accomplished by Objectively modeling the Intrinsic Value of the stocks and selecting those stocks that have the smallest (and even negative) purely Subjective component in their Market Value.

Stocks have Objective Intrinsic Value. The decrease of the Subjective component in the Market Value of the Value Currency is hedged by selecting the stock portfolio to maximize Safety Margin. The Safety Margin is the margin between the Objective Intrinsic Value of the stock and its Subjective Market Value, as for example simply expressed in the price earnings ratio.

Selecting a portfolio with maximal Safety Margin, minimizes the risk of loss of Value over the longer time, as has been successfully proven by Graham and Buffet.

Hedging the Short Risk of Value Loss

The arbitrating between Objective Intrinsic and Subjective Market Value, regularly done by Bank Partners to manage the Money Supply is a the stabilization procedure a Currency needs to stabilize ever fluctuating Subjective Market Value (as saving and reminting were in History). The short term fluctuating Subjective Market Value is stabilized around the Objective Intrinsic Value which secures the Value over the longer term. This hedges the short term risk of loss of Value.

Hedging the Monetary Risk of Other Currencies

An important contributor to the volatility of stock prices is the volatility of the Value of Money.

When the Value of the currency in which the Market Value of the stock is expressed, diminishes the price of the stock will increase, as is the case with the price of any other good.

The geographical selection of the Value Stock Portfolio is done in such way that it reflects the importance of the trading partners. When trade with a certain foreign currency is x%, then x% of the Value Stock Portfolio is selected in that foreign currency.

When that foreign currency decreases Value, the foreign stock will increase in price and the Value Currency will remain constant in Value, since the price increase compensates the decrease of Value of the foreign currency, reflected in its exchange rate.

A product bought or sold in such foreign currency that decreases Value will increase price, the decreasing exchange rate compensate this increase.

The average competitive strength of the community's economy is naturally hedged by this simple procedure and Monetary Confusion is not imported, neither are the five related disadvantages.

Hedging Risk of Government and Private Market Manipulation

Contemporary governments have the power, through their (loosely) controlled central banks, to increase the Money Supply of their Fiat Currency. Also private speculators can increase the Money Supply by loaning Fiat Money. Shorting this loaned Currency destabilizes the Value of that Fiat Money, which Market Value will subsequently converge closer to its intrinsic Value, as e.g. the 1992 Soros speculation against the Pound proved.

The risk of government or private shorting with loaned Value Money, against the Complementary Value Currency is hedged by making the Value Currency a full reserve currency. When Value Money is loaned, its Money Supply therefore does not increase. Every downwards manipulation of the Market Value, has necessarily first an upwards effect on the Market Value, because the full reserve currency needs to be bought before it can be sold, it cannot be created in a different way by the manipulator. Any manipulation of the Market Value of the Value Currency can be arbitrated by the Central Value Bank, through its Bank Partners, transferring Value from the manipulator to the Community and the Partner Banks.

Hedging the Risk of Value Loss Protects Against Financial Crises

All risks of absolute Value loss are hedged. Relatively, the Value of the Value Currency could still vary based on the expected economic outlook for the communities trading in that Value Currency, but this is a relative variation which is a property of Value itself. Value is relative. It is the share within future production as a gratuity for contribution to previous production. Therefore Value Money Objectively hedges against all loss of Value and is thus Good Money.

Good Money does not create Monetary Confusion, since its Value is stable. Crises are the result of Monetary Confusion. The Value Currency also protects against imported Monetary Confusion. Therefore the Complementary Value Currency is an Objective hedge against Financial Crises.

Not only the Currency Community, adopting the Value Currency, but also its surrounding host community that distrusts the new Money and does not adopt it but uses the Fiat Currency instead, is protected from instable crises, such as Hyperinflation. The exchange rate with the host community's Fiat Currency is controlled and kept stable, providing the Subjective trust for the host community's Fiat Currency, that it can always be traded in for Value, although this Value will decrease at the host currency's inflation rate.

The maximal inflation rate in the host community's Fiat Currency can be controlled by allowing to build up the market premium of the Complementary Value Currency over a relatively longer period and then arbitrate it back to zero, effectively creating a brake on the speed of adoption of the Value Currency and stabilizing the host community's inflation at the maximal premium of the Value Currency's Market Value above its Intrinsic Value.

The Structure of the Balance Sheet of the Central Value Bank

Guaranteeing the full reserve character of the Value Money is done by bringing Savings and Loans directly on the balance sheet of the Central Value Bank.

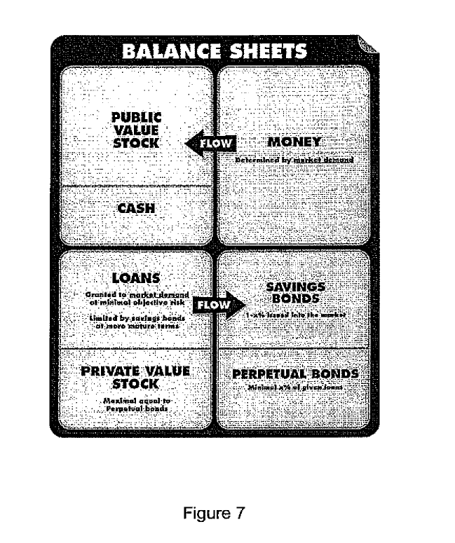

Money is only created when the Bank Partners wire other currencies to the Central Value Bank who is then buying Value stock with these other currencies and creates full reserve Money in return, wired to the Value Bank. This is indicated by the upper Flow arrow in the balance sheets represented in FIG. 7.

Value Currency (as well as some other currency) is held in reserve at the active side of the upper (as well as lower) balance sheet, for trading purposes.

The profit made by selling or buying Value Money at a premium or discount to its Intrinsic Value flows to the Community. This profit adds to a separate balance sheet not represented in FIG. 3, the balance sheet of the Community Representing Entity, discussed further.

The profit or loss made by the increase or decrease of the Market Value of the Value Stock flows to the Intrinsic Value of the Value Sock Portfolio and as such directly to the holders of the Certificates representing the assets on the upper balance sheet. These are the holders of the Money, hence the members of the Currency Community.

The increase of Value over longer time of a Value Stock Portfolio, as proven by

Graham and Buffet, secures the Value of the Complementary Value Currency over the long term, as arbitrating by Banking Partners secures its Value over the short term.

Loaning and Savings

Value Bank loans are granted in Value Currency. These Value Loans are granted directly from the Central Value Bank's second balance sheet, the lower balance sheet in FIG. 3.

The Bank Partners act as brokers when selling these loans to the Currency Community. These earned commissions vest at the moment of loan pay out. This has the extra advantages that income for distressed commercial banks, partnering with the Central Value Bank is accelerated. These accelerated profits allow for reparation of the balance sheets of these banks, which are typically distressed due to impairments to government bonds and other toxic assets.

The Central Value Bank finances the Value Loans, expressed in its own Value Currency, by issuing Saving Bonds in the market, brokered by its Banking Partners, the Value Banks. The risk associated with loan impairments, is covered by issuance of Perpetual Saving Bonds, also brokered by the Value Banks.

As part of this invention, a rule is applied (and transparently communicated to the public) fixing a minimal boundary condition on the percentage of outstanding Value Loans covered by Perpetual Saving Bonds. A fraction of Savings Bonds may be held in cash for practical and trading reason. The amount of Perpetual Saving Bonds is the maximal boundary condition for Private Equity Value Stock, as shown in FIG. 3.

The profit or loss generated by the Value Loans and the Private Equity Value Stock assets on the lower balance sheet of FIG. 3, are allocated to the holders of the Perpetual Saving Bonds.

The interest rate of the Value Saving Bonds is determined by its market price, when issued.

A liquidity rule under the Value Banking System is that Saving Bonds redemption terms should always be pro rate more mature than Value Loans redemption terms.

The interest rate charged on Value Loans is that same interest rate, increased with the commission for Value Banks and a margin reflecting the average loan impairment percentage, which is periodically fixed and transparently communicated to the public.

Enforcing Rules of Free-Market Banking

The Value Banking System rules are freely and voluntarily applied when licensing this invention as Central Value Bank, Bank Partner, Currency Community member or Currency Community Representative Organization. E.g. 1) the Central Value Bank assets and liabilities can solely consist of those represented on FIG. 3 while respecting the boundary conditions as indicated in this Disclose, or 2) the valid tendering of the Value Currency as a means of settling debt, is freely and voluntarily agreed among Currency Community members when they buy the Value Currency or 3) the redistribution of profits (as a Free and Voluntary Tax, when distributed to the Currency Community) is freely and voluntarily agreed when buying Value Currency or Value Saving Bonds. No new legislation is necessary to implement this invention.

Value Investing Rules

Public, as well as Private Equity, Value Shares are selected based on maximal relative Safety Margin or margin of safety between Subjective Market Price and Objective Intrinsic Value, taking into account various boundary conditions. This Safety Margin optimization criterion can be the price earnings ratio, or the method disclosed or any other criterion that Objectively expresses Fear for loss of Intrinsic Value of the Value Share. Under the rules of the Value Banking System the Central Value Bank is not allowed to include purely Subjective criteria, expressing Desire for gain of Market Value. Therefore the optimization criterion expresses an Objective Safety Margin and not Subjectively expected or imagined gain. A Value Certificate can only be successful or Good Money, if Fear is Objectively hedged, since evolution has learned us that the successful way to deal with Fear is to Objectify it.

Boundary conditions take only into account Objectified real risk, such as available market liquidities to hedge illiquidity risks, currency geographies to hedge contamination by the Monetary Confusion in other currency geographies, balance strength to hedge financial risks, etc.

The Safety Margin may be calculated as Graham and/or Buffet do, although not obligatory. Under the rules of the Value Banking System the Value Investing Rules applied by the Central Value Bank should be Objective and transparently communicated to the public, while the stock portfolio itself is not published, unless from time to time as required by law and other regulations, the Central Value Bank is bound to.

Collaborative or Cooperative

Good banking should be an Objective Left Brain activity that does not Subjectively speculate and therefore does not Desire profit or Value, it only hedges the Fear of money losing Value and not being trustworthy.

Good banking is therefore not entrepreneurial, but is a collaborative effort of Objectively securing Value in money. The preferred implementation of the Central Value Bank is therefore a cooperative bank and not a private enterprise.

Also the redistribution of the Free Tax, the profit transferred to the Community Representing Organization and realized by the Central Value Bank on the arbitration, executed by Partnering Banks requires a cooperative attitude or structure.

Under the rules of this disclosure holders of Saving Bonds can assign their share in the future Free Tax Profits, to specific community projects. Their share corresponds to the percentual share they own, at that future moment in time when profits are redistributed, in the total Saving Bonds on the passive of the lower, second balance sheet of the Central Value Bank.

The Community Representing Organization organizes the selection of projects that candidate as beneficiaries of these redistributed profits, purely on Objective grounds, without Subjective (e.g. political) preferences. The Community Representing Organization also organizes the control and pay out of the moneys to these projects, factually becoming a redistribution organ of Free Tax.

Excluded Activities and Related Activities

Some financial activities may be organized under the same brand as that of the Community Representing Organization and/or the Central Value Bank, but with a different and entirely separated balance sheet, meaning no liabilities or risks may be shared between these activities and the Central Value Bank. Such activities are called Excluded Activities, since they are excluded from the balance sheet of the Central Value Bank and Related Activities since they can be executed under the same brand as that of the Community Representing Organization and/or the Central Value Bank.

Insurance activity is such a Related Activity. It becomes Value Insurance Activity when insurance risks are Objectified and investment of the insurance premium is done using

Value Investing. A Left Brain Interface should preferably be used to guide the investment as well as the insurance process. A potential pay out under a Value Insurance claim should be limited in time and amount.

Life insurances and life annuity are Related Activities that should be separated from Value Insurance Activity, since life and its duration is not Objectifiable, with sufficiently high accuracy or low remaining pure Subjectivity. After all life is the Objective name of the Subjective transcendence in nature over material reality.

Dashboard Interfacing

In accordance with the disclosure in the systems disclosed herein, all banking processes may be automated in software, and, regardless of software automation, may be maximally left brain similar to other computer traditional user interfaces. The right brain processes may be interfaced through a management dashboard 23, as illustrated in FIG. 2, which functions as, an interface between bank management decision engine 24 and the system 27 or other system 10. In the illustrative embodiment, the dashboard 23 enables 1) defining new or extra rules, 2) changing existing rules in order to hedge newly perceived or differently perceived risks to the value safety margin of value stock, or 3) changing loan granting rules or general rules or parameters and variables used. In addition to actively changing these system parameters, the dashboard interface also allows for the analysis of performance and general functioning of the system in automated and non-automated modes.

The dashboard 27 comprises a first or right brain user interface display 80, used predominantly for viewing of video content which, in the illustrative embodiment, may be implemented with television display and an accompanying remote controls. A second or left brain user interface in system 27 predominantly uses and/or stimulates activity in the left hemisphere of the human brain, and also, to a limited extent, the right hemisphere of the human brain. System 27 may be implemented with a traditional personal computer, including a desktop or laptop system, as well as other systems. In an exemplary embodiment, dashboard 33 presents visual, non-textual information while computer 27 displays textual and/or numeric information and graphics.

Semi-Automatic Trading System with Left Brain Interface

In order to minimize the level of Desire and the associated Right Brain Consciousness activity, the trading system used by the Central Value Bank should be semi-automated and Objectively structured.

This automatic trading is based on a mathematical and thus Objective software model that models the Margin of Safety between the current trading price and the current intrinsic Value of the traded asset (e.g. share). In a first embodiment the model incorporates an optimization function for the Margin of Safety between the current price and the Value of a security, calculated by dividing the price through the total percentual weighted historic earnings and/or paid out dividends and/or other Value indicators. By minimizing this function with boundary conditions consisting of balance sheet risks and other risks such as geopolitical risks, monetary inflation risks, perceptual and absolute exposure risk and other risks, the best buys are selected. A risk is defined as an Objectively defined Fear for loss; it cannot Subjectively be defined as a loss of opportunity. At times the trading system cannot fully automatically function, manual intervention is allowed, but Subjective judgment should be minimized.

Non-exceptional manual intervention is done through a Left Brain software interface.

Such left brain software interface is designed to limit the available Actions only to Actions that are related to objectively modeled Fears or risks. For example a manual trade or new automatic trading rule in order to optimize return is not allowed and therefore blocked in the interface.

Dashboard with Right Brain Interface

During exceptional periods, entering a new boundary condition that models a new or altered risk is allowed and well supported in the interface. Exceptional periods are periods during which new Objective risks are detected in the environment, not periods during which new Subjective opportunities are experienced.

All processes dealing with minimizing known risks may under the Value Banking

System be maximally automated in software and, regardless of software automation, should be maximally Left Brain.

However, detecting unknown threats and devising hedging strategies is an activity of the Right Brain Consciousness. The Right Brain processes are interfaced through a dashboard, as illustrated in FIG. 2, which functions as, an interface between Central Value

Bank management decision engine and the participating bank system. In the illustrative embodiment, the dashboard enables 1) analyze phenomena graphically, 2) defining new or extra rules and running simulations on past data, 3) changing existing rules in order to hedge newly perceived or differently perceived risks to the Value safety margin of Value stock and run simulations, or 4) changing loan granting rules or general rules or parameters and variables used and run simulations.

In addition to actively changing the system parameters, the dashboard interface also allows for simulation of newly proposed hedging strategies and graphical analysis/synthesis of performance and general functioning of the system in automated and non-automated modes.

Semi-Automatic Trading System with Left Brain Interface

In order to minimize the level of desire and the associated right brain consciousness activity, the trading necessary for deposit taking and associated value investment and for deposit pay out and associated value disinvestment should be maximally automated.

This automatic trading is based on a mathematical software model that models the margin of safety between the current trading price and the value of the stock or bond. Such model incorporates an optimization function for the margin of safety between the price and the value of a security weighing and totaling historic and/or predicted earnings and/or dividends paid out and/or other value indicators as well as boundary conditions consisting of balance sheet risks and other risks such as geopolitical risks, monetary inflation risks, perceptual and absolute exposure risk and other risks. Risk is defined as an objectively defined fear for loss, not subjectively defined and not as a loss of opportunity. If such trading system cannot be executed fully automatically, manual intervention may be exceptionally allowed.

Non-exceptional manual intervention may be done through a left brain software interface. Such left brain software interface may be designed to limit the available actions to actions that are related to objectively modeled fears or risks. For example, a manual trade or new automatic trading rule in order to optimize return is not allowed and therefore blocked in the interface, however entering a new boundary condition that models a new or altered risk is allowed and well supported in the interface.

Management Cost

The operational cost of the Central Value Bank cannot exceed a previously determined and transparently communicated percentage of the outstanding bank's money and savings bonds.

Transparency

The Central Value Bank's standards and rules, including choices of variables (such as the numerical Value of mentioned percentages) are transparently communicated to the public and rigorously applied and enforced. The Central Value Bank's bylaws reflect this disclosure's rules. Management is liable in case of willful breach. Bylaws can be changed to a those of a Central non-Value Bank, when the majority of votes of savings bonds holders desires so, but only if the Central Value Bank pays out the no voters who wish so.

Software Implementation of a Safety Margin Algorithm

The Objective Profit of a company is defined as the ex post realized profit. The priced Subjective Profit is the profit expected by all investors participating in the stock market. An efficient stock market is one where the market priced profit equals the Objective Profit. This is illustrated in FIG. 6. In an efficient market all stocks are positioned on the 45-degree line. The Safety Margin is the distance above the 45-degree line. For those companies the Objective Profit is larger than the Subjective Profit expected by investors. The maximal

Safety Margin in the graph is the top left part, where the Objective Profit is strongly positive and the priced Subjective Profit is strongly negative.

FIG. 5 illustrates the algorithmic process 800 for developing a Value Stock portfolio utilizing one or more of the computer systems and software described herein. Specifically, the process for creating an equity portfolio by computing for each equity instrument i) an objective fundamental criteria, and ii) a subjective market criteria, as illustrated by process blocks 802 and 803. In the illustrative embodiment, the Objective fundamental criteria may comprise any number of criteria such as valuation multiples, profitability criteria, solvency criteria and liquidity criteria with regard to the most recent fiscal year available. Similarly, Subjective market criteria, may comprise criteria such as market capitalization and average daily turnover. In the illustrative embodiment, network accessible memory 30 and 20 of system 10 is utilized to store data on a plurality of equity instruments, each equity instrument associated with an entity issuing the equity instrument, for example, a sovereign tea, government agency, corporation. The nature type of the equity instrument may be chosen from a large plurality of different equity instrument types.

In one embodiment, the underlying equity instrument s comprising the asset that substantiates the currency comprises at least one of: a stock; a commodity; a futures contract; a bond; a mutual fund; a hedge fund; a fund of funds; an exchange traded fund (ETF); a derivative; and/or a negative weighting on any asset. Such equity instruments may also comprise any of a debt instrument; at least one unit of interest in at least one of: an asset; a liability; a tracking portfolio; a financial instrument and/or a security, where the financial instrument and/or the security denotes a debt, an equity interest, and/or a hybrid; a derivatives contract, including at least one of: a future, a forward, a put, a call, an option, a swap, and/or any other transaction relating to a fluctuation of an underlying asset, notwithstanding the prevailing value of the contract, and notwithstanding whether such contract, for purposes of accounting, is considered an asset or liability; a fund; and/or an investment entity or account of any kind, including an interest in, or rights relating to: a hedge fund, an exchange traded fund (ETF), a fund of funds, a mutual fund, a closed end fund, an investment vehicle, and/or any other pooled and/or separately managed investments.

In another embodiment, an objective metric of intrinsic value of an equity instrument, which serves as the underlying asset substantiating the currency, may comprise at least one of: revenue; profitability; sales; total sales; foreign sales, domestic sales; net sales; gross sales; profit margin; operating margin; retained earnings; earnings per share; book value; book value adjusted for inflation; book value adjusted for replacement cost; book value adjusted for liquidation value; dividends; assets; tangible assets; intangible assets; fixed assets; property; plant; equipment; goodwill; replacement value of assets; liquidation value of assets; liabilities; long term liabilities; short term liabilities; net worth; research and development expense; accounts receivable; earnings before interest and tax (EBIT); earnings before interest, taxes, dividends, and amortization (EBITDA); accounts payable; cost of goods sold (CGS); debt ratio; budget; capital budget; cash budget; direct labor budget; factory overhead budget; operating budget; sales budget; inventory system; type of stock offered; liquidity; book income; tax income; capitalization of earnings; capitalization of goodwill; capitalization of interest; capitalization of revenue; capital spending; cash; compensation; employee turnover; overhead costs; credit rating; growth rate; tax rate; liquidation value of entity; capitalization of cash; capitalization of earnings; capitalization of revenue; cash flow; and/or future value of expected cash flow.

In another embodiment, the universe of entities with which an equity instrument may be associated may include at least one of: a sector; a market; a market sector; an industry sector; a geographic sector; an international sector; a sub-industry sector; a government issue; and/or a tax exempt financial object; agriculture, forestry, fishing and/or hunting industry sector; mining industry sector; utilities industry sector; construction industry sector; manufacturing industry sector; wholesale trade industry sector; retail trade industry sector;

transportation and/or warehousing industry sector; information industry sector; finance and/or insurance industry sector; real estate and/or rental and/or leasing industry sector; professional, scientific, and/or technical services industry sector; management of companies and/or enterprises industry sector; administrative and/or support and/or waste management and/or remediation services industry sector; education services industry sector; health care and/or social assistance industry sector; arts, entertainment, and/or recreation industry sector; accommodation and/or food services industry sector; other services (except public administration) industry sector; and/or public administration industry sector.

In other embodiments, the underlying asset base substantiating an amount of currency comprises equity instruments other than debt instruments of a government or sovereignty.

Next, any equity instrument having an associated value for the objective fundamental criteria and the subjective market criteria outside a predefined range of values, e.g., outliers, is eliminated from the equity instrument data set, as illustrated by process block 804. Thereafter, a risk minimization processes is utilized which, in one embodiment, may comprise, for each of the plurality of equity instruments, scaling a ratio of the computed value of the objective fundamental criteria to the computed value of the subjective market criteria of the equity instruments by at least one weighting criteria so as to minimize risk, as illustrated by process block 806. In another embodiment, the risk may be minimized utilizing a linear equation having the form:

min [valuation multiple i*portfolio weights]

which is solved for each of the plurality of equity instruments, using the value for the objective fundamental criteria and the subjective market associated with the equity instrument and at least one predefined weighting criteria, as also illustrated by process block 806. The predefined weighting criteria may be stored in memory 20 of system 10 as one or more rules 21 interoperable with decision engine 24. Such rules may, for example, have the form of any of the following:
Rule 1—No more than x% (of the total value of the equity portfolio) shall be invested in one
Rule 2—No more than y₁% could be invested in one country;
Rule 3—No less than y₂% could be invested in one currency region;
Rule 4—The portfolio's profitability criteria must be in the upper α^{th} percentile;
Rule 5—The portfolio's solvency criteria must be in the upper β^{th} percentile;
Rule 6—The portfolio's liquidity criteria must be in the upper γ^{th} percentile;
Rule 7—The portfolio's valuation multiples (except for valuation multiple i) must be in the lower zth percentile.

In one embodiment, in Rule 1 the value of x may be between 0%-5% but more preferably between 0%-2%, but even more preferably between less than 1%. In additional the value of x may be pre-determined or calculated dynamical y by a separate risk model.

In one embodiment, in Rule 2 and Rule 3, y1 and y2, respectively, may have vales depending on matching the ratio of foreign trade currencies in the foreign trade of the community using the currency, with the ratio of selected stock expressed in those foreign currencies.

In one embodiment, in Rules 4, 5 and 6, alpha, beta and gamma, respectively, are typical higher best quarter selections, and may have values between 1%-100%, but more preferably between 50%-100% but even more preferably between 75% and 100%.

In one embodiment, in Rule 7,z may have a value representing a lower best quarter selection, and may have values between 0%-100%, but more preferably between 0%-50% but even more preferably between 0% and 25%.

Thereafter, only those equity instruments resulting in positive weight values in step 808 are retained within the equity portfolio, as illustrated by process block 810. The exemplary embodiments of the above-described Safety Margin algorithm described herein is for illustrative purposes and are not meant to be limiting.

Although the various embodiments of the system and techniques disclosed herein have been described with reference to equity instruments in the form of stock, the system described herein, particularly the portfolio models may be equally utilized with other types of equity instruments with substantially the same disclosed system and techniques as would be understood by those reasonably skilled in the relevant arts, given the disclosures as set forth herein.

It will be obvious to those reasonably skilled in the art that modifications to the systems and processes disclosed herein may occur, without departing from the true spirit and scope of the disclosure. For example, any two elements which communicate over a network or directly, may utilize either a push or a pull technique in addition to any specific communication protocol or technique described herein. Further, notwithstanding the network implementation described, any existing or future network or communications infrastructure technologies may be utilized, including any combination of public and private networks. In addition, although specific algorithmic flow diagrams or data structures may have been illustrated, these are for exemplary purposes only, other processes which achieve the same functions or utilized different data structures or formats are contemplated to be within the scope of the concepts described herein. As such, the exemplary embodiments described herein are for illustrative purposes and are not meant to be limiting.

What is claimed is:

1. An article of manufacture for use as currency comprising:
A) a token representation of an amount of value as an amount of currency;
B) an underlying asset having an intrinsic value associated with the amount of currency; and
C) a mechanism for substantiating the value of the currency with the underlying asset.

2. The article of manufacture of claim 1 wherein the mechanism for substantiating comprises a smart chip associated with the currency.

3. The article of manufacture of claim 1 wherein the mechanism for substantiating comprises a resolvable computer address embedded in the token representation of the currency.

4. The article of manufacture of claim 1 wherein the mechanism for substantiating comprises an alert mechanism for indicating if the intrinsic value of the asset associated with the amount of currency has exceeded a predetermined threshold range of values.

5. A method for transacting the exchange of goods/services comprising:
A) providing an amount of goods or services having a value associated there with;
B) providing an amount of currency having an assigned value associated therewith, the currency further comprising a mechanism for substantiating the currency's value with an asset base having an intrinsic value, associated with the amount of currency; and
C) exchanging the amount of goods or services for the verified or substantiated amount of currency.

6. The method of claim 5 further comprising:
D) verifying that the traded value of the currency is substantially similar to the intrinsic value associated with the currency's asset base.

7. The method of claim 6 wherein D) comprises:
D1) confirming that a portfolio of at least one equity asset associated with the token representation of the currency has an intrinsic value at least substantially equal to the assigned value of the amount of currency.

8. The method of claim 5 wherein the asset base comprises other currency instruments.

9. The method of claim 5 wherein the asset base comprises a combination of equity instruments and other currency instruments.

10. The method of claim 5 wherein the asset base comprises a equity instruments other than debt instruments of a government or sovereignty.

11. A method of preventing fluctuations in the value of a tangible currency or an intangible token of such tangible currency or an intangible currency, the method comprising:
A) providing an amount of a tangible currency or of an intangible token of such tangible currency or of an intangible currency, as a tangible or intangible token representing an amount of value, the amount of currency having a numerical nominative value;
B) substantiating the intrinsic value of the amount of currency with a portfolio of equity instruments by making the amount of currency a certificate representing ownership or profit rights in the portfolio of equity instruments; and
C) utilizing a model of intrinsic value of the amount of currency and/or a model of intrinsic value of the equity instrument portfolio to hedge risks of diminishing value of the amount of currency.

12. The method of claim 11 wherein B) comprises:
B1) modeling an absolute or relative safety margin between the modeled intrinsic value of an equity instrument and a market price of the equity instrument, in order to select and/or reselect the equity instrument portfolio substantiating the amount of currency.

13. The method of claim 12 wherein B) further comprises:
B2) selecting equity instruments as part of the portfolio to hedge one of foreign exchange risks and risks of import of monetary instability from other currencies, for users of the amount of currency.

14. The method of claim 13 wherein B) further comprises:
B3) matching the ratio of foreign trade currencies in the foreign trade of the community using the currency, with the ratio of selected stock expressed in those foreign currencies.

15. The method of claim 12 wherein C) comprises:
C1) hedging long term risk to the currency value, by using a price to value safety margin model.

16. The method of claim 15 wherein C) further comprises:
C2) hedging short term risk to the currency value by arbitrating subjective value of the currency against objective value of the currency, directly or indirectly through market makers.

17. The method of claim 15 wherein C) further comprises:
C2) hedging short term risk of the currency value by arbitrating market value of the currency against intrinsic value of the currency, directly or indirectly through market makers.

18. The method of claim 17 wherein C) further comprises:
C3) the intrinsic value of the currency is modeled based on the market value of its underlying equity instrument portfolio and/or on the intrinsic value of its underlying equity instrument portfolio.

19. The method of claim 18 wherein C) further comprises:
C4) the intrinsic value of the underlying stock portfolio is determined based on a model as in B1).

20. The method of claim 11 further comprising:
D) exchanging an amount of goods or services having a value substantially equal to the value of an amount of currency, using that amount of currency as a means of exchange.

21. The method of claim 11 wherein the amount of currency has the form of coins, paper or plastic currency, or electronic certificates.

22. The method of claim 11 wherein selection of equity instruments in the portfolio of equity instruments is based on at least one predetermined rule for hedging long term risk.

23. The method of claim 11 wherein arbitrating price against intrinsic value of the equity instrument is performed in accordance with at least one predetermined rule for hedging short term risk.

24. The method of claim 21 wherein the tangible or intangible currency or its electronic token has a verification mechanism associated with representation of the amount of currency for enabling confirmation or verification of the intrinsic value associated with the amount of the currency.

25. The method of claim 24 wherein the value verification mechanism comprises a resolvable computer address embedded in a representation of the currency.

26. The method of claim 24 wherein the value verification mechanism comprises an alert mechanism for indicating if the instantaneous intrinsic value of the amount of currency has exceeded a predetermined maximal threshold or subceeded a predetermined minimal thresholds.

27. A method for creating an equity instrument portfolio substantiating a tangible or intangible currency comprising:
A) from data stored in a network accessible memory, the data representing a plurality of equity instruments, each equity instrument associated with an entity issuing the equity instrument, computing for each equity instrument:
i) an objective fundamental criteria, and
ii) a subjective market criteria;
B) eliminating the equity instrument associated with any entity having an associated value for the objective fundamental criteria and the subjective market criteria outside a predefined range of values;
C) for each of the plurality of equity instruments, scaling a ratio of the computed value of the objective fundamental criteria to the computed value of the subjective market criteria by at least one weighting criteria so as to minimize risk; and
D) retaining within the equity portfolio only those equity instruments resulting in positive weight values in C) above.

28. The method of claim 27 wherein the at least one predefined weighting criteria requires that less than 1% is invested in one company entity.

29. The method of claim 27 further comprising:
E) associating the equity instrument portfolio with an amount of currency having a value dependant on the intrinsic value of the equity instrument portfolio.

30. The method of claim 29 wherein the equity instrument portfolio is associated with a currency as defined in claims 1.

31. The method of claim 27 wherein the at least one predefined weighting criteria requires that the portfolio's profitability criteria is in the upper 75% to 100% percentile.

32. The method of claim 27 wherein the at least one predefined weighting criteria requires that the portfolio's solvency criteria is in the upper 75% to 100% percentile.

33. The method of claim 27 wherein the at least one predefined weighting criteria requires that the portfolio's liquidity criteria is in the upper 75% to 100% percentile.

34. The method of claim 27 wherein the at least one predefined weighting criteria requires that the portfolio's valuation multiples, except for the valuation multiple i, are in the 0% to 25% percentile.

35. The method of claim 27 wherein the objective fundamental criteria comprises any of valuation multiples, profitability criteria, solvency criteria and liquidity criteria with regard to the most recent fiscal year available.

36. The method of claim 27 wherein the subjective market criteria comprises any of market capitalization and average daily turnover.

37. A computerized banking system comprising:
A) at least one network accessible central bank system comprising:
i) a network interface;
ii) at least one processor;
iii) a memory for storing an executable equity portfolio model and a plurality of predefined rules associated with selection or trading of equity instruments and the issuance of currency, the currency; and
B) a plurality of participating bank systems coupled over a network to the central bank system, each of the participating bank systems comprising a user interface for enabling automated and semi-automated interaction with the central bank system over a network.

38. The system of claim 37 wherein the memory of the central bank further stores an executable equity portfolio model incorporating an optimization function for maintaining a relationship between a current trading price and a current intrinsic value of a traded equity instrument and/or a traded currency of that central bank and/or other currencies.

39. The system of claim 38 wherein the relationship between the current trading price and the current intrinsic value of the traded equity instrument and/or the currency it substantiates is calculated by dividing the price through the total perceptual weighted historic earnings and/or paid out dividends and/or other value indicators.

40. The system of claim 37 wherein the participating bank systems may perform any of:
i) analyzing phenomena graphically, ii) defining new or extra rules and running simulations on past data, iii) changing existing rules in order to hedge newly perceived or differently perceived risks or remodel the value safety margin of value equity and run simulations, or iv) changing loan granting rules or general rules or parameters and variables used and run simulations.

41. The method of claim 5 wherein the asset base comprises an equity instrument portfolio created using the method of claim 17.
